(19) United States
(12) Patent Application Publication
(10) Pub. No.: US 2007/0239507 A1
(43) Pub. Date: Oct. 11, 2007

(54) Systems and methods for scheduling child play dates

(76) Inventor: Sushil Madhogarhia, West Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/401,689

(22) Filed: Apr. 11, 2006

(51) Int. Cl. G06F 9/46

(52) U.S. Cl. 705/8

(57) ABSTRACT

The present disclosure discloses methods and systems for scheduling play dates. In one embodiment, a user, such as, for example, a parent and/or child, interface with a play date finder and scheduling system through a network. The user is able to quickly locate and schedule potential play dates. The scheduling system also provides a feedback and history system to rate and keep track of play dates that have taken place.

### FIELD OF THE INVENTION

The present invention relates to the field of play date scheduling, more specifically, the present invention relates to a system for scheduling and coordinating play dates.

### BACKGROUND

With the advent of computers and video games, children spend more and more time in front of a machine rather than interacting with each other. They begin to lose friends, social skills and are more likely to get into drugs, drop out of school and be less productive to society than those children that are able to develop proper social skills. It is important for a child to develop proper social skills and to have a social circle of friends and relatives that they can interact with and who care about them. Play dates are one example of a way to pull children away from TVs, computers, and video games and allow them to interact with other children with mutual interests. Unfortunately, in today's increasingly busy society, parents and children often do not have the time or are unable to coordinate their schedules to allow for play dates. In addition, it is often difficult for children and parents to find other children with similar interests and similar backgrounds.

### SUMMARY OF THE DISCLOSURE

In order to address these needs, the present disclosure discloses a system for scheduling child play dates. The system provides a network interface in which parents and children are able to log on and find, as well as schedule, play dates with other children who have similar interests and similar backgrounds.

In one embodiment, a network-based scheduling system is disclosed. The network-based scheduling system includes a child schedule database, a child parameter database, a parent database, a parameters module, a scheduling module, an identification module and a communication module. The child schedule database includes a plurality of child schedules. The plurality of child schedules includes at least a first child schedule corresponding to a first child. The child parameter database includes a plurality of child parameter sets. The plurality of child parameter sets includes at least a first child parameter set corresponding to the first child. The parent database includes a first parent schedule. The parameters module compares the first child parameter set with the plurality of child parameter sets in the child parameter database in order to find one or more second child parameter sets. Each second child parameter set in the second child parameter sets contains at least one similar parameter to the first child parameter set. The scheduling module compares the first child schedule and the first parent schedule with the plurality of child schedules in the child schedule database in order to find one or more second child schedules. Each of the second child schedules in the second child schedules have one or more open time periods that correspond to open time periods on the first child schedule and the first parent schedule. The identification module identifies one or more children with a parameter list and a schedule on the one or more second child parameter sets and the one or more second child schedules in order to suggest one or more children with whom the first child can schedule an event. The communication module communicates with the one or more children about the event.

In one embodiment, the child schedule database and the child parameter database are a single database. In one embodiment, the plurality of child schedules in the child schedule database includes child schedules corresponding to the one or more second child parameter sets. In one embodiment, the plurality of child preference sets in the child preference database includes child preference sets corresponding to the one or more second child schedules. In one embodiment, the communication communicates an event invitation. In one embodiment, the communication communicates an event reminder. In one embodiment, the communication module communicates a follow up request after the event.

In one embodiment, A method for matching a first child with a second child for an event is disclosed. The method includes the steps of: providing a database of child parameters including at least a set of first child parameters of a first child and a second child parameters of a second child; providing a database of child schedules including at least a first child schedule of the first child and a second child schedule of the second child; providing a database of parent schedules including at least a first parent schedule of a first parent, wherein the first parent is the parent of the first child; coordinating the schedules of the first parent and the first child based on the first child schedule and the first parent schedule; searching the database of child schedules for a subset of child schedules that coordinate with at least one period of time with the coordinated schedule of the first parent and the first child; identifying the subset of child schedules that coordinate with at least one period of time with the coordinated schedules of the first parent and the first child; searching the database of child parameters for a subset of child parameter sets that have one or more similar parameters to the set of first child parameters; identifying the subset of child parameter sets that have one or more similar parameters to the set of first child parameters; comparing the identified subset of child schedules with the identified subset of child parameter sets for a child listed on both subsets; and identifying one or more children listed on both subsets.

In one embodiment, identifying one or more children listed on both subsets includes: searching for a child with the most similar set of parameters when two or more children are listed on both subsets; and identifying the child with the most similar set of parameters.

In one embodiment, a network-based scheduling system is disclosed. The network-based scheduling system includes: a child database including a first child schedule and a second child schedule; a parent database including a first parent schedule; a scheduling module which compares the first and second child schedules and the first parent schedule in order to match an open time period on the first child schedule, the second child schedule, and the first parent schedule in order to schedule an event; and a logistics module which coordinates the logistics associated with attending the event.

In one embodiment, the network-based scheduling system includes a communication interface for communication between the schedule module and a user. In one embodiment, the communication is an invitation email. In one embodiment, the communication is a reminder email. In one embodiment, the communication is a follow up email. In one embodiment, the schedule module schedules an event. In one embodiment, a history module is provided for recording information about completed events. In one embodiment, system includes an activity module for suggesting events.

In one embodiment, the child database further includes a set of child parameters. In one embodiment, child database includes location information about a first child. In one embodiment, the child database further includes interest information about a first child. In one embodiment, the interest information includes affiliation information. In one embodiment, the affiliation information comprises school affiliation. In one embodiment, the affiliation information comprises religious affiliation.

In one embodiment, a scheduling method for scheduling a child play date is disclosed. The scheduling method includes: providing a first child schedule; providing a second child schedule; providing a first parent schedule; coordinating the first child schedule, the second child schedule, and the first parent schedule in order to schedule an event. In one embodiment, coordinating the parent schedule further comprises coordinating a transportation period. In one embodiment, coordinating the transportation period comprises coordinating a transportation period at the beginning of the event. In one embodiment, coordinating the transportation period comprises coordinating a transportation period at the end of the event. In one embodiment, coordinating the transportation period comprises coordinating a transportation period at the beginning and the end of the event. In one embodiment, the scheduling method includes providing a second parent schedule; and coordinating the first child schedule, the second child schedule, and the first parent schedule with the second parent schedule.

In one embodiment, a network-based social interface system is disclosed. The network-based social interface system includes: one or more databases; a registration module which obtains and stores registration information of one or more users on the one or more databases; a calendar module which obtains and stores schedule information of the one or more users on the one or more databases; a user finder module which obtains parameter information from a first user and searches the one or more databases for a subset of the one or more users that have registration information that is similar to the obtained parameters and store identification information of the subset of the one or more users on the one or more databases; and a communication module which communicates with the one or more users.

In one embodiment, the first user is a child. In one embodiment, the first user is a parent. In one embodiment, a scheduling module is also included in the system. The scheduling modules compares schedule information of the subset of one or more users with schedule information of the first user. In one embodiment, a discussion group module is included in the system. The discussion group module posts comments from the one or more users. In one embodiment, the communication module communicates an invitation to the subset of one or more users. In one embodiment, the communication module communicates a reminder. In one embodiment, the communication module requests feedback about an event. In one embodiment, the system includes a history module which stores and displays history information about an event.

In one embodiment, a method of scheduling a social event is disclosed. The method includes: obtaining scheduling information about a first user and one or more second users; obtaining a plurality of social event requests from a first user for the one or more second users; automatically scheduling a social event between the first user and the one or more of the second users in response to one or more of the plurality of social event requests and the occurrence of an event. In one embodiment, the event is a passage of time. In one embodiment, the event is a completion of a previous event. In one embodiment, the event is a user input.

In one embodiment, an event scheduling probability based scheduling system is disclosed. The event scheduling probability based scheduling system includes a calendar database with a plurality of scheduled events and a probability module which computes a probability of scheduling an event at a specified time based on the scheduled events in the calendar database. In one embodiment, a display module is included which displays the probability computed by the probability module. In one embodiment, the probability module computes the probability of scheduling an event during a blocked out period. In one embodiment, the probability module is further configured to compute the probability of scheduling an event during a non-blocked out period. In one embodiment, a calendar module is also included which displays a calendar displaying the plurality of scheduled events.

In one embodiment, an event history system is disclosed. The events history system includes an events database which gives feedback information about events, a statistical module configured to compute statistical information based on the feedback information, and a display module for displaying computed the statistical information. In one embodiment, the statistical information includes statistical information about one or more participants of an event. In one embodiment, the statistical information includes statistical information about one or more activities at the event. In one embodiment, the statistical information includes statistical information about logistic information associated with the event.

### BRIEF DESCRIPTION OF THE DRAWINGS

The drawings and the associated descriptions are provided to illustrate embodiments of the disclosure and not to limit the scope of the claims.

FIG. 1 illustrates an overview of the play date scheduling system.

FIG. 2 illustrates a play date home page.

FIG. 3 illustrates a list of kids' parameters.

FIG. 4 illustrates a list of parents' parameters.

FIG. 5 illustrates a list of preferences.

FIG. 6 illustrates a play date welcome page.

FIG. 7 illustrates a list of activities for play dates.

FIG. 8 illustrates a search system for finding other children to play with.

FIG. 9 illustrates an email requesting access permission.

FIG. 10 illustrates a display of a child's information.

FIG. 11 illustrates a page for choosing favorites to play with.

FIG. 12 illustrates a scheduling calendar system.

FIG. 13 illustrates a scheduling calendar system with an advice box for scheduling play dates.

FIG. 14 illustrates a schedule calendar with automatic display of child information.

FIG. 15 illustrates a schedule calendar with a click to schedule play date function.

FIG. 16 illustrates a daily schedule calendar.

FIG. 17 illustrates an e-mail play date invite.

FIG. 18 illustrates a play date logistics e-mail.

FIG. 19 illustrates a play date reminder e-mail.

FIG. 20 illustrates a play date follow-up e-mail.

FIG. 21 illustrates a play date follow-up page.

FIG. 22 illustrates a play date history page.

FIG. 23 illustrates a discussion group page.

FIG. 24 illustrates a discussion group thread page.

FIG. 25 illustrates a flow chart of the play date scheduling system.

FIG. 26 illustrates a diagram of security levels and access availability.

FIG. 27 illustrates a flow chart of an automatic play date finder.

### DETAILED DESCRIPTION

Embodiments of the present disclosure include methods and systems for scheduling play dates. In one embodiment a user interfaces with a play date finder and scheduling system through a network. A user is defined herein to include a parent and/or a child. A parent is defined herein to include a natural or adoptive parent, grandparents, a legal guardian, a child's primary care taker, or any other person responsible for the child, including, for example, a school administrator, or a religious leader. In one embodiment, the user can be a group of users, such as, for example, one or more parents and a child, or parents and grandparents, etc. The user is able to quickly locate potential play dates. The user is also able to quickly and efficiently schedule a play date. The scheduling system also provides a feedback and history system to rate and keep track of play dates that have taken place.

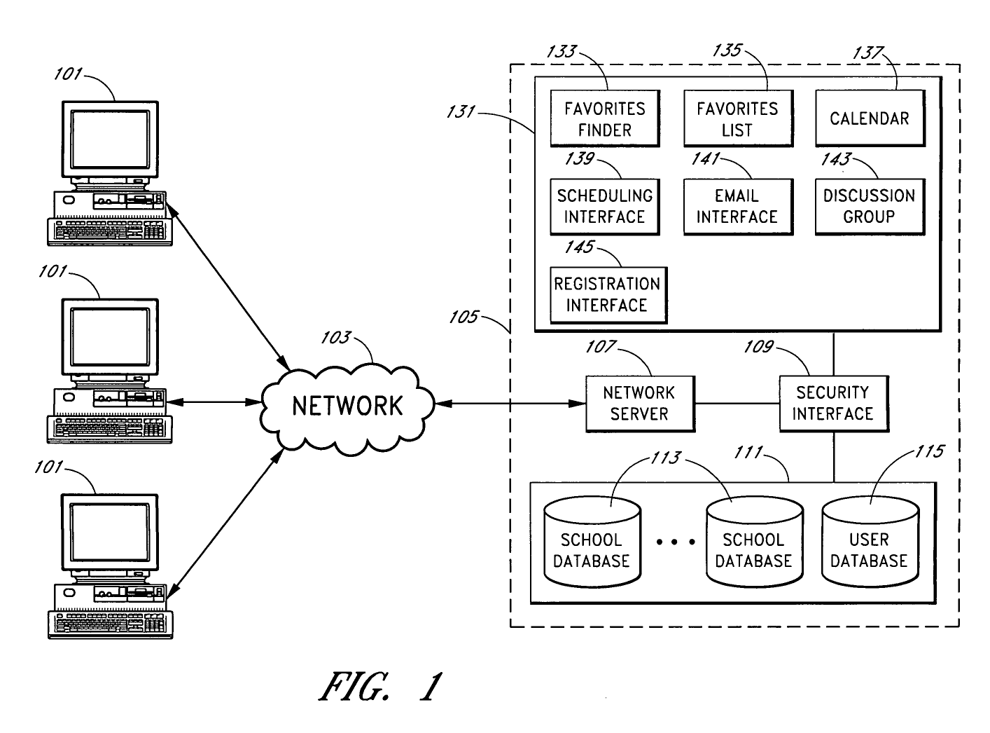

FIG. 1 illustrates one embodiment of a network-based play date scheduling system. A user logs onto the computers 101 and access the network 103 which connects them to the play date network server 107. Computers 101 can be any device capable of accessing a network, such as, for example, desktop computer, a laptop computer, a cell phone, a personal digital assistant (“PDA”), a television, etc. The network can be any network of communicating computers, including, such as, for example, the internet or a private network. The network server 107 interacts with the security interface 109 which blocks unauthorized users from accessing either the play date interface 131 or the database 111. The database 111 stores information relevant to scheduling play dates. The database 111 can be a single database or multiple databases. In one embodiment, the school database 113 is provided which stores information relevant to various students who attend a particular school. In one embodiment, the user database 115 is provided where users can store their information. Other databases can also be included in the present system.

FIG. 1 also illustrates the play date interface 131. In one embodiment, the play date interface 131 includes the favorites finder module 133, the favorites list module 135, the calendar module 137, the scheduling interface module 139, the e-mail interface module 141, the discussion group module 143 and the registration interface module 145.

In operation, a user uses a computer, such as the computer 101 to access the play dates scheduling system network server 107 through a network 103. The user then either registers or logs in. A user then interfaces with play date interface 131 in order to, such as, for example, find a favorite, find a play date or schedule a play date. While the user is interfacing with the interface modules 131, the interface modules retrieve and store information on database 111.

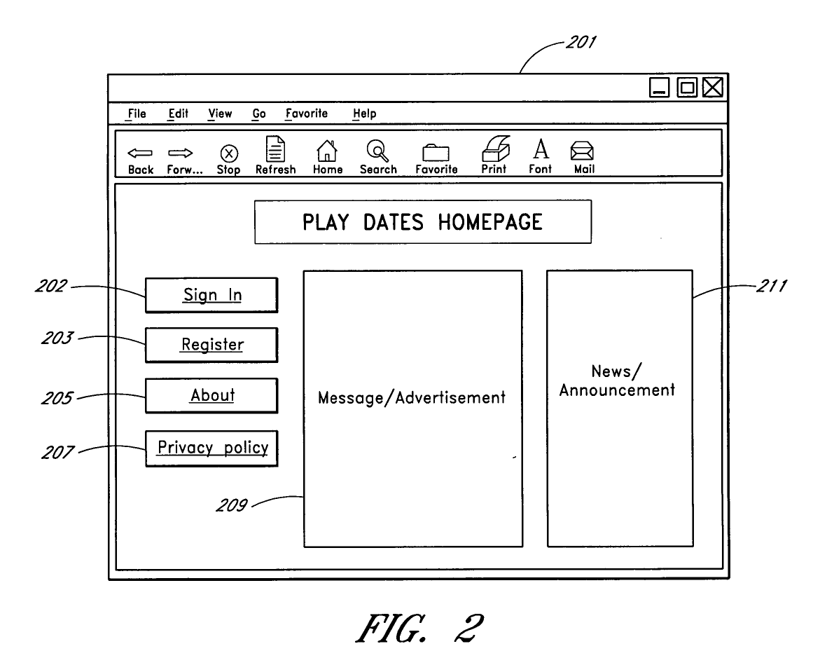

FIG. 2 illustrates one embodiment of a play dates home page. When a user accesses the play dates system network server 107, the play dates home page 201, is displayed. The play dates home page 201 has the sign-in link 202, the register link 203, the about link 205, and the privacy policy link 207. In one embodiment, there is also a message or advertising display, such as, for example, the message or advertising display 209, as well as the news announcement column 211. In operation, the user logs in to the play dates home page 210 and clicks on one of the links 202, 203, 205, 207 to sign in, register, find out more about the scheduling system, or read the scheduling system's privacy policy.

If a user has not already registered, the user registers before proceeding to the rest of the scheduling system. In one embodiment, a user completes information requested in one or more network pages. The information requested can include various parameters about the child and/or the parent in order to more effectively match children with each other for play date scheduling. In one embodiment, multiple network pages are displayed. In one embodiment, a network page is displayed for requesting information. In one embodiment, a parent must enter information about their child and/or themselves. In one embodiment, a child can enter information about themselves and their parents. In one embodiment, a child enters information about themselves, and a parent enters information about themselves.

In one embodiment, a user is not required to verify their identity. In one embodiment, a user is required to verify their identity by, for example, submitting verifiable information about themselves. In one embodiment, the verifiable information is a credit card number. In one embodiment, the information is a password supplied to or by a school administrator. In one embodiment, the information is a password supplied to or by a religious institution. In one embodiment, a user submits registration information directly to school administrators, community leaders, or religious leaders. The school administrators, community leaders, or religious leaders are then given security clearance to enter information about parents and children within their purview. In one embodiment, a user enters a school name during registration, and a school administrator or religious leaders verify the information provided during registration. In one embodiment, the school administrator receives a registration verification request when a new user registers.

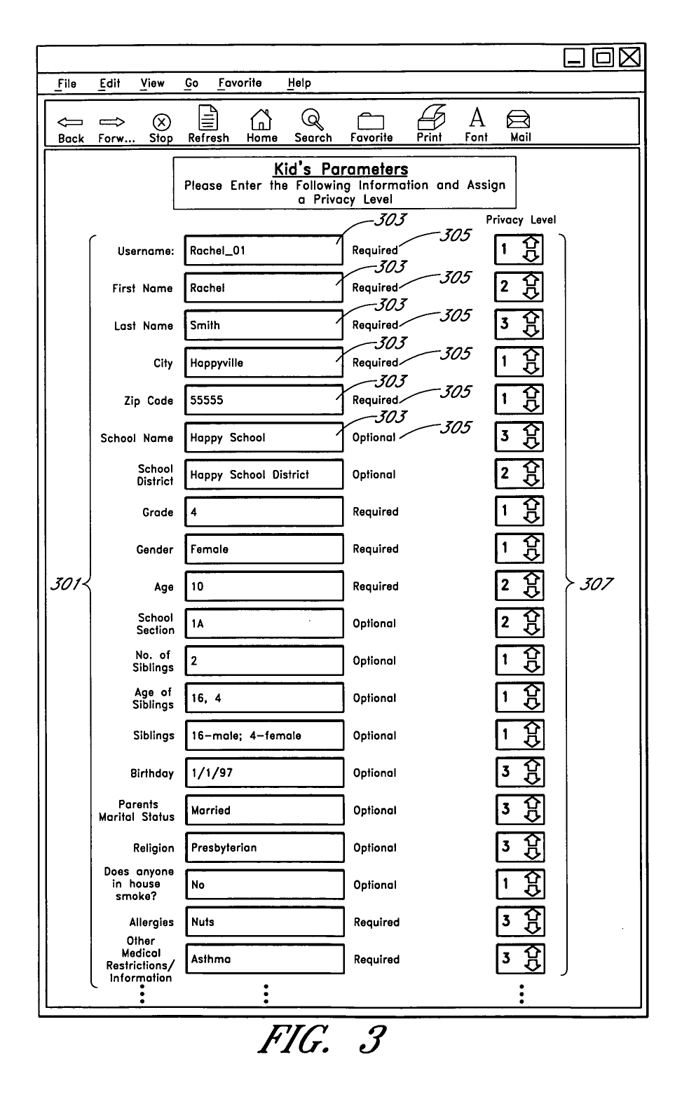

FIG. 3 illustrates one embodiment of a network page requesting child parameters. If a user has not signed into the scheduling system before, the user signs in and provides the requested information. In one embodiment, a parent logs in to the play date scheduling system. In one embodiment, the child logs in to the play date scheduling system and is allowed to schedule play dates with or without their parent's permission. In one embodiment, the child logs in to the play date scheduling system with the child's parents' permission and/or the child's parents' presence while the child operates within the site. In one embodiment, a child can log in and browse for play dates but cannot actually schedule a play date without their parent's permission. In one embodiment, while browsing, a child can select a desired play date and can tentatively schedule the play date. The play date is then later approved by a parent. In one embodiment, a child can pre-select a number of desired play dates and the play dates system automatically schedules one or more play dates from the pre-selected list upon the occurrence of an event. The event can include, such as, for example, the completion of the previously scheduled play date, the passage of a period of time, or some other specified event occurrence. In one embodiment, a parent specifies which part of the play date scheduling system his or her child can access.

In one embodiment, the system includes an instant messaging capability. A child can instant message with other registered children. In one embodiment, a child can only instant message with approved children. In one embodiment, a parent must approve the children with whom their child can engage in instant messaging. In one embodiment, a child can instant message with anyone in a designated group, such as, for example, a school, a church, a community, or a city.

Parameters 301 include information pertinent in matching children for play dates. Parameters can include, such as, for example, a user name, first name, last name, city, zip code, school name, a school district, grade, gender, age, school section, number of siblings, age of siblings, gender of siblings, parents' birthday, children the user has had play dates with, parent's marital status, religion, whether anyone smokes in the house, allergies or other medical restrictions, and children the user plays with on a regular basis, favorite game, favorite food, food she hates, favorite movie, favorite TV show, favorite computer game, favorite instrument, favorite sports, classes she enjoys, classes she does not enjoy, favorite activities at play date, activities not enjoyed at play date, lives with mom, lives with dad, lives with both parents, favorite toys, vegetarian, disabilities, best way to reach parent in case of emergency, favorite activities at play date, or other useful parameters. The user then enters the requested information into the corresponding fields 303. In one embodiment, the required/optional indicators 305 indicate whether a particular field is a required field or an optional field. If the field is required, the registration process is not completed until the requested information is entered. If the field is optional, a user can choose whether to provide the information, and the registration process is completed even if the user chooses not to answer the question. In one embodiment, a user can enter optional information at a later time, or update information previously provided.

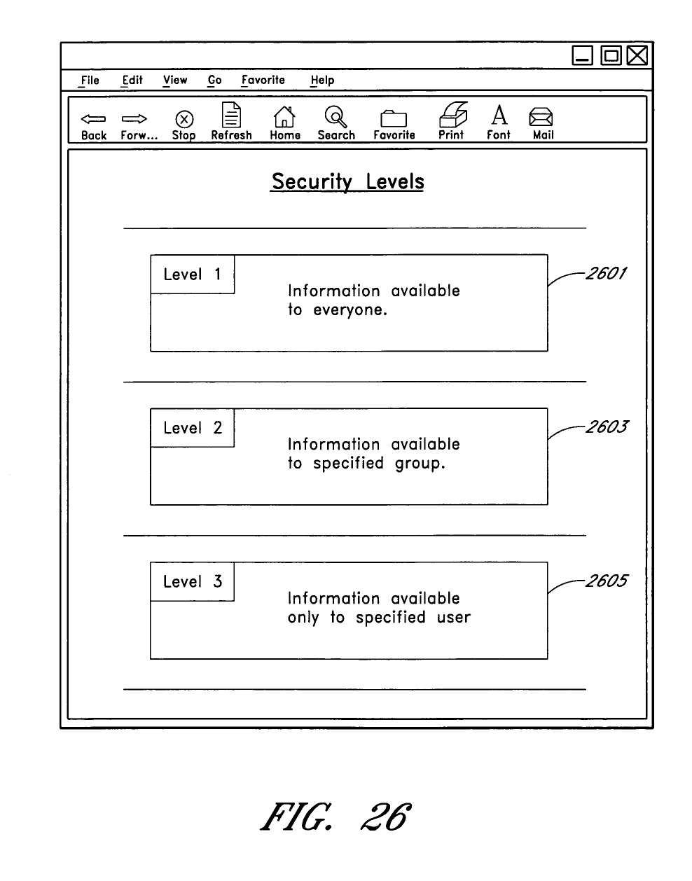

In one embodiment, each parameter has a corresponding privacy level 307 associated with it. A user chooses which privacy level certain parameters are given, for example, a user name can be set to privacy level of 1 and a first and last name can be set by the user to a privacy level of 2 or 3. The various privacy levels are discussed with reference to FIG. 26.

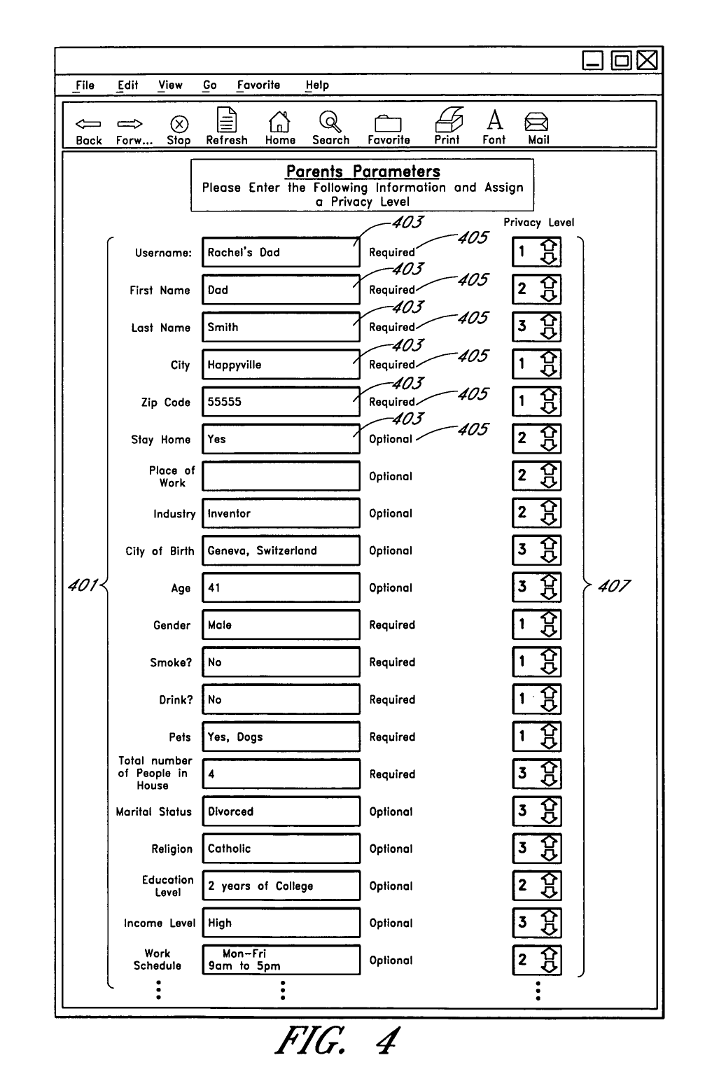

In addition to children's parameters, in one embodiment, a user is also requested to enter information about the parent. FIG. 4 illustrates one embodiment of a network page requesting parent parameters. Information about the parent can be requested in order to further aid in matching children for play dates. Parent parameters 401 can include, such as, for example, a user name, first name, last name, address, city, zip code, whether the parent stays at home during the day, place of work, industry, city of birth, age, gender, whether the parent or someone in the house smokes, whether the parent or someone in the house drinks, whether they have pets, the total number of people in the house, marital status, religion, education level, income level, work schedule, cell phone, home phone, high school name, college name, best way to contact a parent, best time for parents to meet, age of other children, whether siblings are generally around during play dates, if the parent is willing to pick up or drop off, what is the best way to get hold of the parent, would the parent be home at the time of the play date, or would a babysitter be there, would the parent be able to drop their child off, does the parent hang out after or before school, maximum play date distance, any play date association restrictions, for example, restricting a child to play dates with children from the same school or neighborhood, what are the ages of the child's siblings, as well as any other parameter useful in matching children for a play date. A user enters the requested information in fields 403. The required/optional indicators 405 indicate which fields are required and which are merely optional. The privacy level options 407 allow the user to select a privacy level to assign to each parameter.

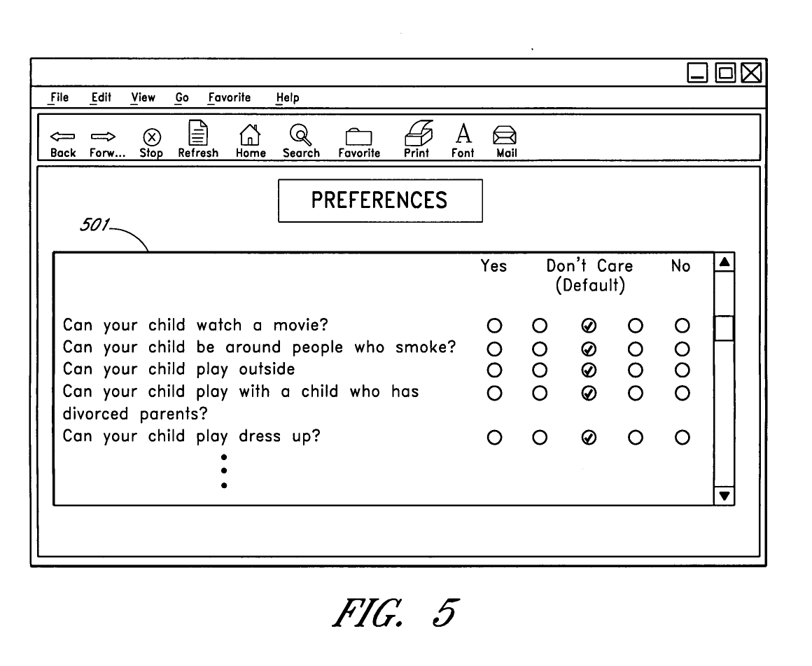

In one embodiment, a preferences page is also provided to allow a user to list preferences about the play dates for their children. FIG. 5 illustrates one embodiment of a preferences page in which a user answers a number of questions 501. The questions 501 generally concern activity, food, location, atmosphere, or other preferences about participating in a play date. A user can then answer questions 501 by filling in the appropriate responses in area 503 by selecting an appropriate response by clicking on the appropriate box 505. The default box 507 is provided as the initial default for every question. The default box is provided so that a user only has to respond to the questions which the user cares about. The preferences can include such questions as: “can your child watch a movie;” “can your child go to a movie;” “can your child cook;” “can your child wash a car;” “can your child play dress up;” “can your child go to the library;” “can your child go to a bookstore;” “can your child be supervised by a babysitter;” “can a mother supervise your child;” “can a father supervise your child;” “can your child paint;” “can your child be around people that smoke;” “can your child play with a child who has divorced parents;” “would you be able to pick up the child on short notice in case of an emergency;” “can you be relied on to be notified with very little time to pick kids up if needs be;” “do you mind being reached on your cell phone;” “do you mind being paged;” “do you mind being called at home;” “do you mind being e-mailed;” etc.

Once the registration information is obtained, the registration process is complete. In one embodiment, the user is then directed to a personalized welcome page and/or sent a confirmation email with their registration information. All of the information obtained is then be stored in the database 111 for storage and later retrieval. A user is allowed to later modify their responses.

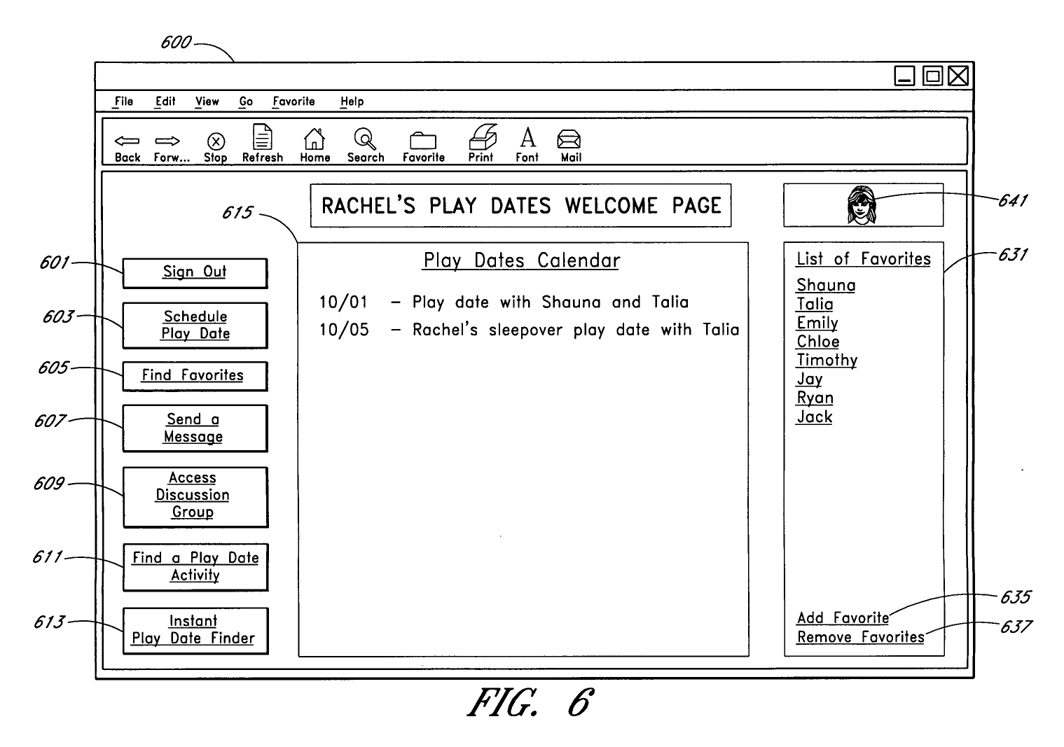

FIG. 6 illustrates one embodiment of a play dates welcome page. The play dates welcome page 600 has sign-out link 601, schedule play date link 603, find favorites link 605, send a message link 607, discussion group link 609, find a play date activity link 611, and instant play date finder link 613. In addition, the play date calendar display 615 displays play dates that have been scheduled. A list of favorites column 631 displays a number of users which have been chosen as favorites by the user that is logged on and looking at their home page. Each welcome page can be personalized for each particular user. In addition, an add favorites link 635 and a remove favorite link 637 can be provided so as to find and add new favorites as well as remove favorites.

A user can log off of the play date scheduling system by clicking on the sign-out link 601. Once the sign out link has been clicked, a user is directed to the play date scheduling homepage. By clicking on the schedule play date link 603, a user is directed to a play date scheduling page which guides the user through the play date scheduling process. A user can click on the find favorites link 605, which directs a user to a page which assists the user in finding other children to schedule play dates with. The send a message link 607, when clicked, directs a user to a page where the user can send an email to another user. The discussion group link 609, directs a user to a discussion group page, where the user can participate in various discussion groups. The find a play date activity link 611 directs a user to a page containing a list of suggested activities for play dates. The instant play date finder 613, when clicked, automatically searches through the user's and the favorite's calendars' in order to automatically find and schedule a play date at the first available time with a child in the favorites list. If a user does not have any favorites listed in their list of favorites, the instant play date finder 613 also automatically matches a user to potential play dates, in order to schedule a play date. The scope of the search for potential play dates can be limited by a distance, such as, for example, 30 miles, or by a affiliation with a specified group, such as, for example, a school or church. In one embodiment, the instant play date finder link 613, when clicked, automatically searches through the user's and the favorites' calendars and then displays a list of the favorites with the first available play date time for each favorite as well as a schedule play date link for each favorite. The user can then quickly schedule a play date by clicking on the schedule play date link of the favorite they wish to schedule a play date with.

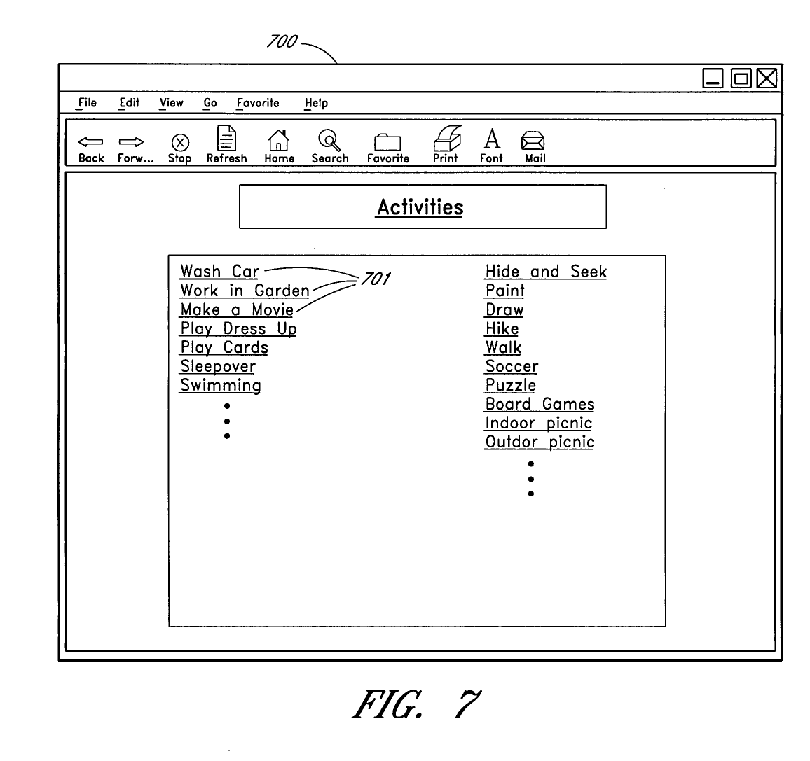

FIG. 7 illustrates one embodiment of an activities page 700. In one embodiment, the activities page 700 is linked directly from the welcome page, as described above. In one embodiment, the activities page 700 is available through a link on the play dates homepage 201 to entice a potential registrant to register and use the system. In one embodiment, the activities page 700 is also linked from various stages of the scheduling process in order to provide ideas for activities to users. Activities page 700 lists a number of activities 701. The user looking at the activities page can scroll down through a list of activities with a short description. Each short description doubles as a link to a longer description of the activity. Thus, when a user clicks on the short description, the user is directed to a page with a longer description of each activity. In one embodiment, links are provided to a list of names of users or favorites who have participated in the activity. I one embodiment, links are provided to pages with comments on a particular activity by users who have participated in those activities. Activities on the activity page can include such activities as, such as, for example, wash car, work in garden, make a movie, play dress up, play cards, sleep over, swimming, hide and sick, paint, draw, hike, walk, soccer, puzzle, board games, indoor picnic, outdoor picnic, kitchen activities, play beauty parlor, get crafty, arrange old photos, sort coins, organize bookshelf, go online, sit outside and blow soap bubbles, play gas station, record on tape recorder, play beads, art, sponge paint, rock paint, collage, spelling contest, puzzle, create own stained glass window, cardboard cut outs, marble paint, make pasta art, make ice cream, clean the kitchen, scavenger hunt, wash the toys, build a computer from old useless computers, play magic, sticker book, musical instruments, floor puzzles, matchbook cards, pretend cash register, bike ride, or marbles. The activities page 700 provides an aid to children and their parents in finding activities which allow for social interaction between the children, aiding social development.

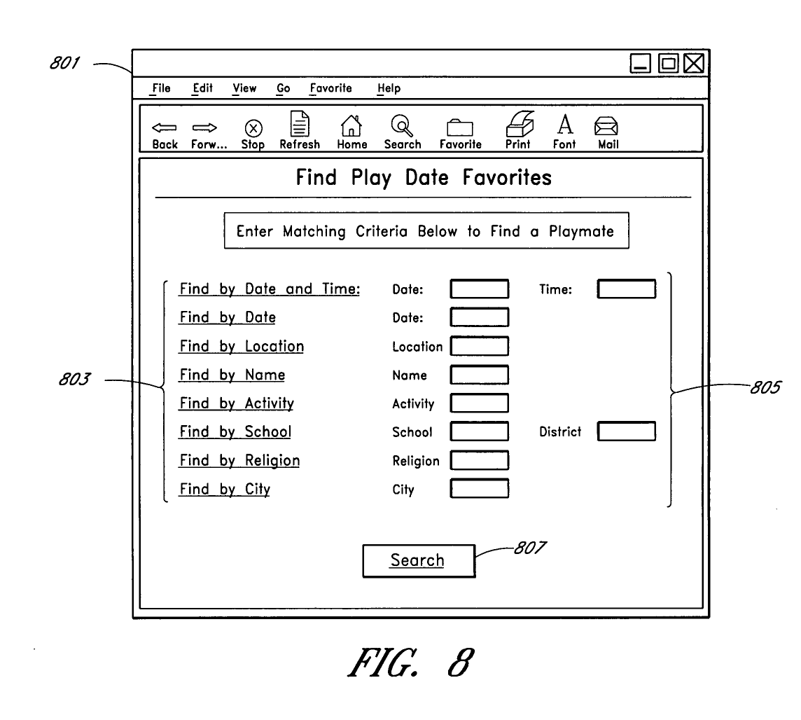

FIG. 8 illustrates one embodiment of a find play dates favorite page. A user can log in to the find play dates favorite page when the user wishes to find a favorite. For example, a user can click on link 605 and then try and find a favorite. The favorite's finder 801 has a number of parameters 803 and a number of fields 805 which coordinate with the parameters 803. Parameters 803 can include such options as: “find by date and time;” “find by date;” “find by location;” “find by name;” “find by activity;” “find by school;” “find by religion;” “find by city;” “find by age;” “find by distance;” find by gender;” or any other information that would be useful in finding a play date. A user can log in and enter information in particular parameters that are important to them. In one embodiment, the parameters are taken from the information entered during registration. The user can enter information in only one parameter, the user can enter information in some parameters, or the user can enter information in every parameter. After the user has entered their information in the parameters, the user can click the search button 807. The system then looks at the parameters entered and searches the database 111 for children with similar matching parameters. In one embodiment, when the favorites finder identifies particular children as possible matches, it displays another page suggesting potential favorites as well as the percent of parameters entered that match to the suggested potential favorite. The user then chooses which suggested potential favorites to add to their favorite list.

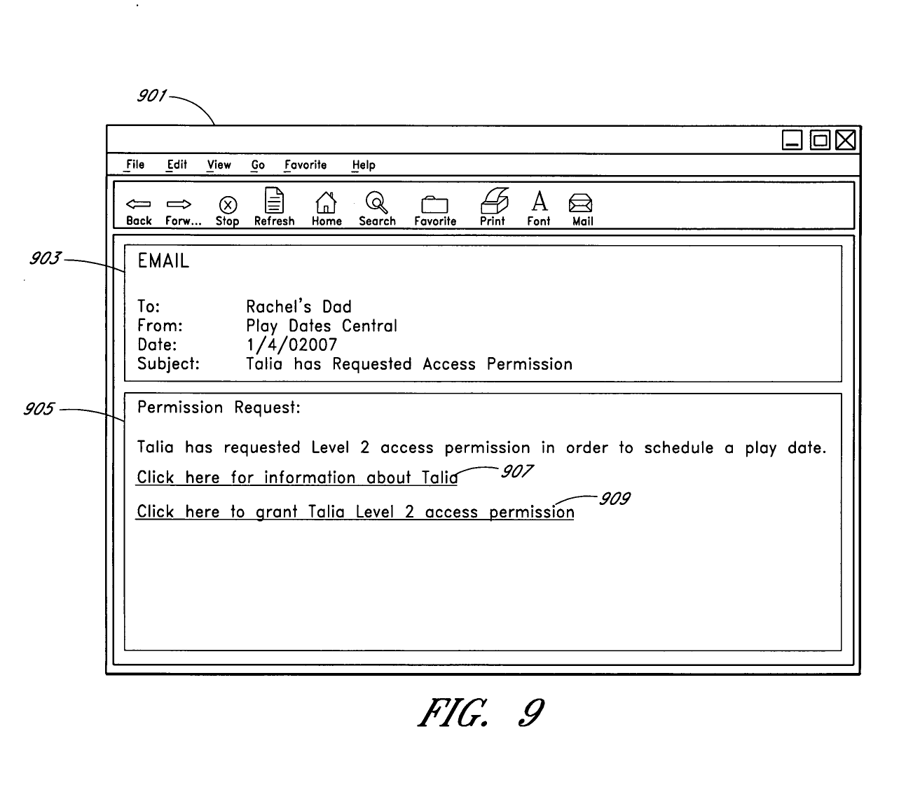

Once the user has chosen a favorite to add, in one embodiment, the user then requests permission from the favorite to access the favorite's information. In one embodiment, if the selected favorite declines to share information with the requesting user, the user is not allowed to request a play date with that favorite. For example, FIG. 9 illustrates one embodiment of an e-mail 901 requesting access permission. E-mail 901 has header information 903 which includes who the e-mail 901 was sent to, who the e-mail 901 was sent from, the date of e-mail 901, and the subject of e-mail 901. In the bottom of the e-mail 901, a user is sent the message 905, such as, for example “Talia has requested level 2 access permission in order to schedule a play date.” The recipient of the e-mail 901 receives several links, such as the link 907 and the link 909. The link 907 directs a user to an information page about the email requestor. The link 907 directs a user to a page which allows the user to grant access permission. Other links may also be provided. For example, in one embodiment a link is provided which contains information about references for a user requesting security access. The references can have the reference's phone number, email address, street address, relationship to requestor, etc. The reference can be a friend, a relative, a school administrator, or a religious leader. In one embodiment, a user being requested to give security access can request references if references have not been provided. In one embodiment a link is provided for requesting more information from the security access requestor. In one embodiment, in addition to clicking on one of the links, the user enters a user name and password in order to view information about the requester or to grant access level permission. In one embodiment, access permission is granted by phone. For example, in one embodiment, a user calls another user over the phone and asks for permission to access a security level. In one embodiment, a user sends a request with their phone number, and the recipient can call the sender to verify that they want to grant access permission.

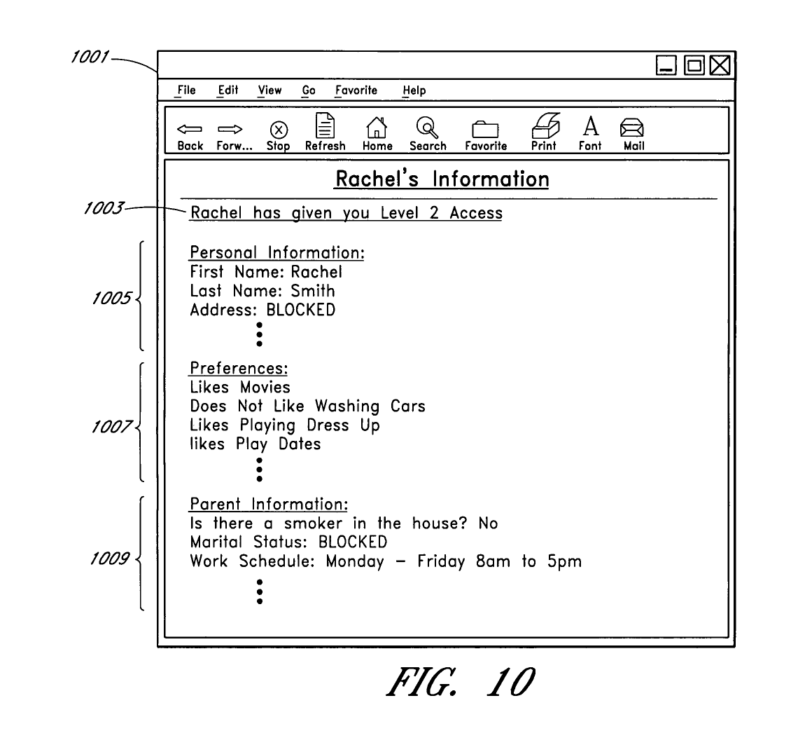

FIG. 10 illustrates one embodiment of a child information page 1001. Once granted access permission, a user can view an information page about another user, such as the child information page 1001. The information page 1001 provides access to information entered by a user during the registration process. If a user only has level one access, a user is able to see level 1 information. Once granted level 2 access, a user is able to see level 2 information, but some information may still be blocked as level three information. In some circumstances, a user can grant another user level three access to their information, which shows all, or most, of the information entered. The child information page 1001 shows one embodiment of an information page available under a level 2 access. The text 1003 displays the favorite's name and access level granted. The text 1005 displays a favorite's personal information. The text 1007 displays a favorite's preferences. The text 1009 displays a favorite's parent's information. As shown in the text 1005, 1007, 1009, certain information has been blocked, such as, for example, a favorite's address, or a parent's marital status for security and privacy purposes. In one embodiment, security level indicators are displayed showing which security level a user must be given to see a particular parameter.

Once a user has found another user the user wishes to schedule a play date with, the user can request a play date with the other user. A user can schedule a play date with one or more other users. A user can also schedule multiple play dates at the same time with the same or different users. There are various ways that a user can schedule a play date. For example, in one embodiment, a user can click on a favorite in a list and schedule a play date. In one embodiment, a user can click on a play date finder link and the system automatically schedules a play date. In one embodiment, a user is allowed to see a side by side calendar where the user can manually find a time that other user's are available to schedule a play date. Various other methods of scheduling a play date will be apparent to one of ordinary skill in the art as well from the present disclosure.

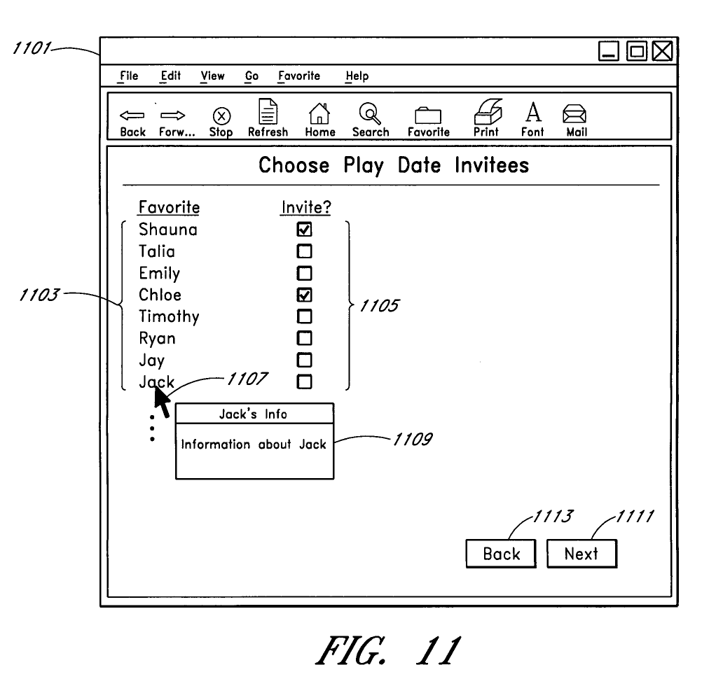

FIG. 11 illustrates one embodiment of a play date scheduling process. When a user clicks on the schedule a play date link 603, the user is directed to the choose play date invitees page 1101. The play date invitees page 1101 displays a list of pre-selected play date favorites and allows the user to decide which favorites to schedule a play date with. The play date invitees page 1101 displays the column of favorites 1103 and the corresponding column of invitee boxes 1105. In order to select a user to invite, a user clicks on a box in the invitee box column 1105 that corresponds to the favorite in the favorite's column 1103 the user wishes to invite. Once a user has selected all of the favorites the user wishes to invite to a particular play date, the user then clicks the next button 1111 to move to the next step in scheduling. In one embodiment, a user can place a mouse pointer 1107 over a favorite's name and the information box 1109 appears which contains information about the favorite. The information box 1109 reminds a user about a particular favorite. The information in the information box 1109 can be selected by a user or automatically selected by the system.

In one embodiment, by clicking on the next button, the system automatically looks at the calendars of the selected invitees to find the soonest time when all are available and provides an option to send out an email to all selected invitees to schedule a play date. In one embodiment, by clicking on the next button, the system then moves to another page, where a user can select an activity and/or a preferred date and/or time for the play date. In one embodiment, by clicking on the next button, a user is directed to a calendar where a user can manually see when the selected invitees are available and can manually select a day and time for the play date.

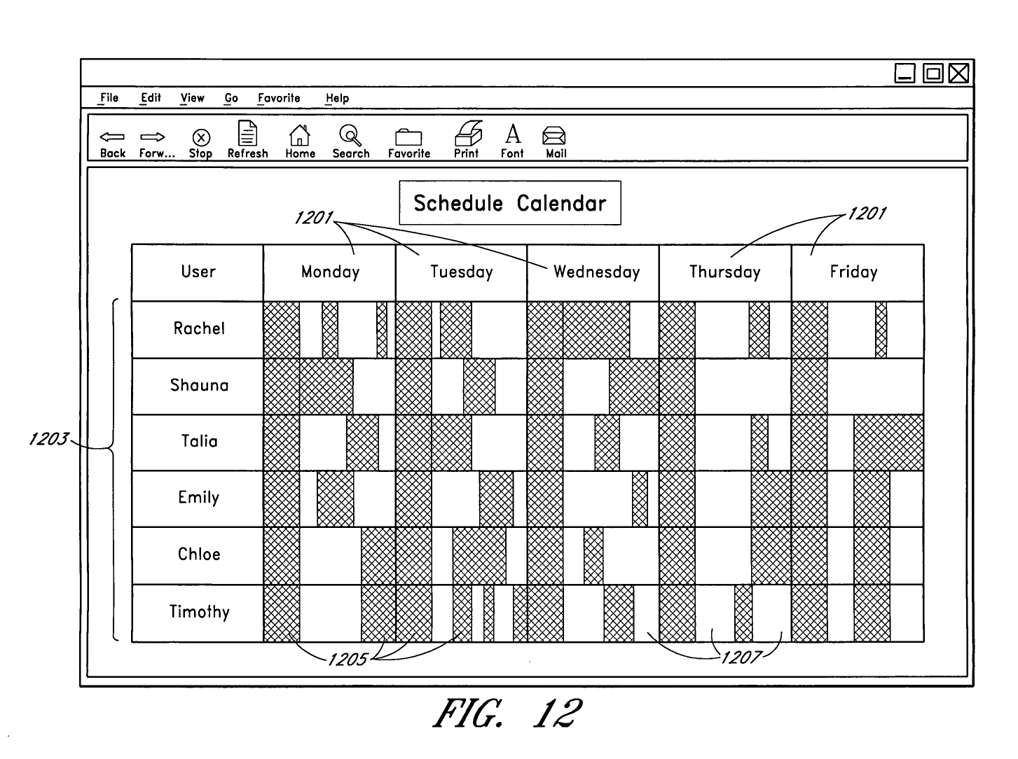

FIG. 12 illustrates one embodiment of a manual schedule system. In addition to being able to manually select a day and time for a play date, a user can view the schedule calendar page to view which play dates the user has already scheduled. The play date calendar system can coordinate only the child's schedule, or it can incorporate both the parent's and child's schedule into one calendar system.

The schedule calendar displays the days of the week 1201 and the user's names 1203. In one embodiment, the schedule calendar only displays the schedule of the user. In one embodiment, the schedule calendar displays the schedules of the user and all of the user's favorites. In one embodiment, the schedule calendar displays the schedule of the user and a selected list of favorite's schedules. In one embodiment, the schedule calendar displays parent schedules in addition to child schedules. In one embodiment, child's schedule and the parent's schedule are incorporated into one schedule display. In one embodiment, the child's schedule and the parents schedules are displayed overlapping. The blocked out times 1205 display when a particular user is unavailable due to another scheduled event. The open slots 1207 display when a particular user is available to schedule a play date. The calendar can display the activity blocking out a particular time, or the calendar can display only that a particular time is blocked, or a combination thereof.

In one embodiment, a user can use the schedule calendar page to block out times that the user is unavailable by, for example, right clicking on a time and selecting a block out time option. In one embodiment, the calendar does not display the reason for blocking out a particular time period. In one embodiment, the calendar does display the reason for blocking out a particular time period. In one embodiment, a user must be given permission to see what event(s) are scheduled during a blocked out period in order to protect other user's privacy. In one embodiment, a user can choose to display to other users what activities the user is involved in during a particular time slot. For example, a user can place a mouse pointer over a time slot and see what activity is blocking out that particular time. In one embodiment, a parent's schedule is also incorporated into the schedule calendar. In one embodiment, a parent and/or child can upload their respective schedules from another scheduling program, such as, for example, Microsoft Outlook.

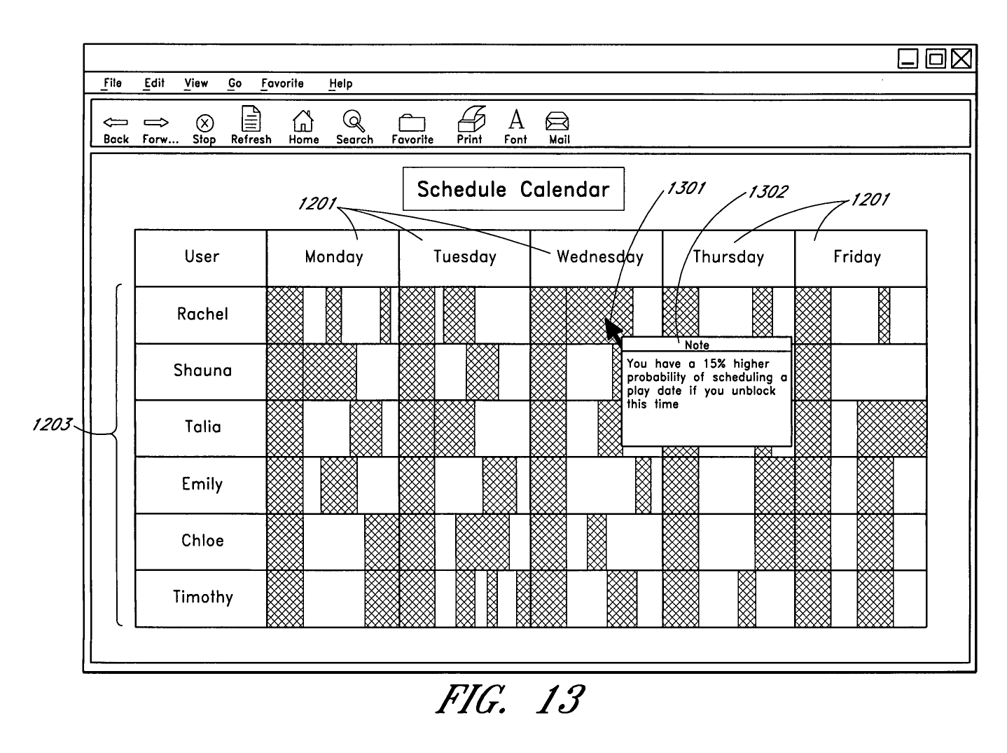

FIG. 13 illustrates one embodiment of a schedule calendar in which a user can place a mouse pointer 1301 over a time slot which is blocked out and the note 1302 pops up. The note 1302 suggests to the user the probability of scheduling a play date if the user unblocks that time period.

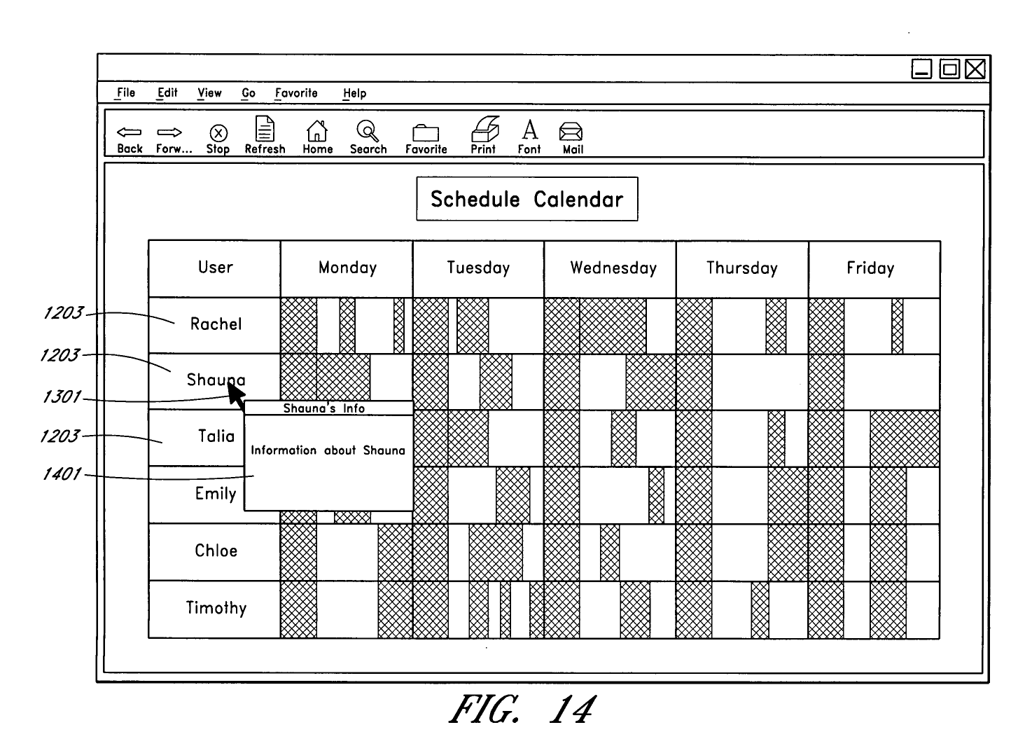

FIG. 14 illustrates one embodiment of a schedule calendar in which a user can place the mouse pointer 1301 over the user name 1203 and the information block 1401 pops up and gives a description of the user. The description can be created by the user to remind them of who other users are, or the description can be automatically generated from registration information provided by the user being described.

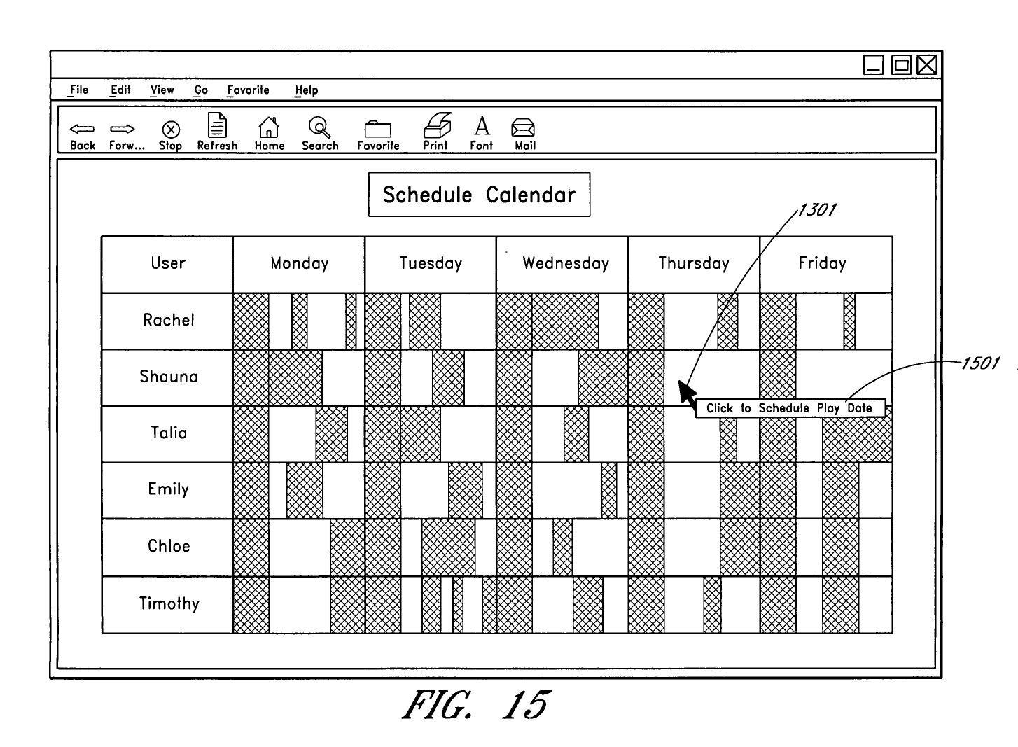

FIG. 15 illustrates one embodiment of a schedule calendar in which a user can place the mouse pointer 1301 over an open slot in the calendar, and by clicking on the slot using their mouse, a user can start the play date scheduling process. As illustrated in FIG. 15, when the mouse 1301 is placed over an open time slot, the note 1501 appears telling the user that by clicking the user can begin the play date scheduling process. In this embodiment, the user effectively begins the scheduling process by first picking a time slot. The system then takes the user through the rest of the scheduling process as described.

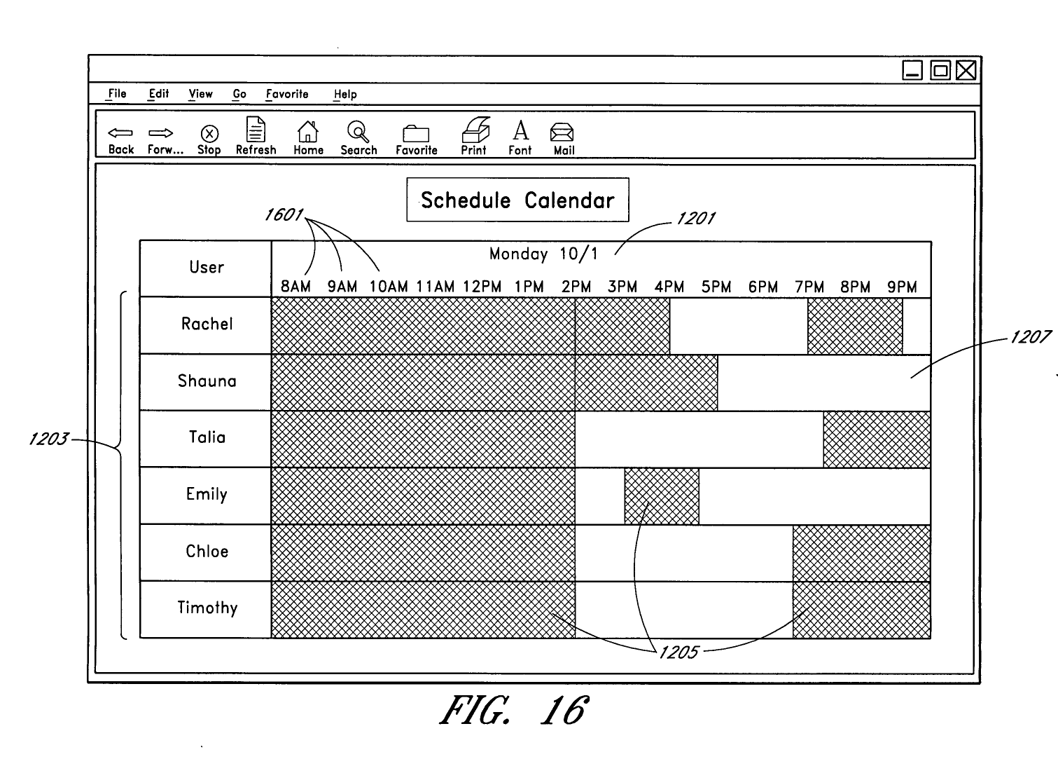

FIG. 16 illustrates one embodiment of a schedule calendar in which the day 1201 is expanded so as to show more detail about a particular day.

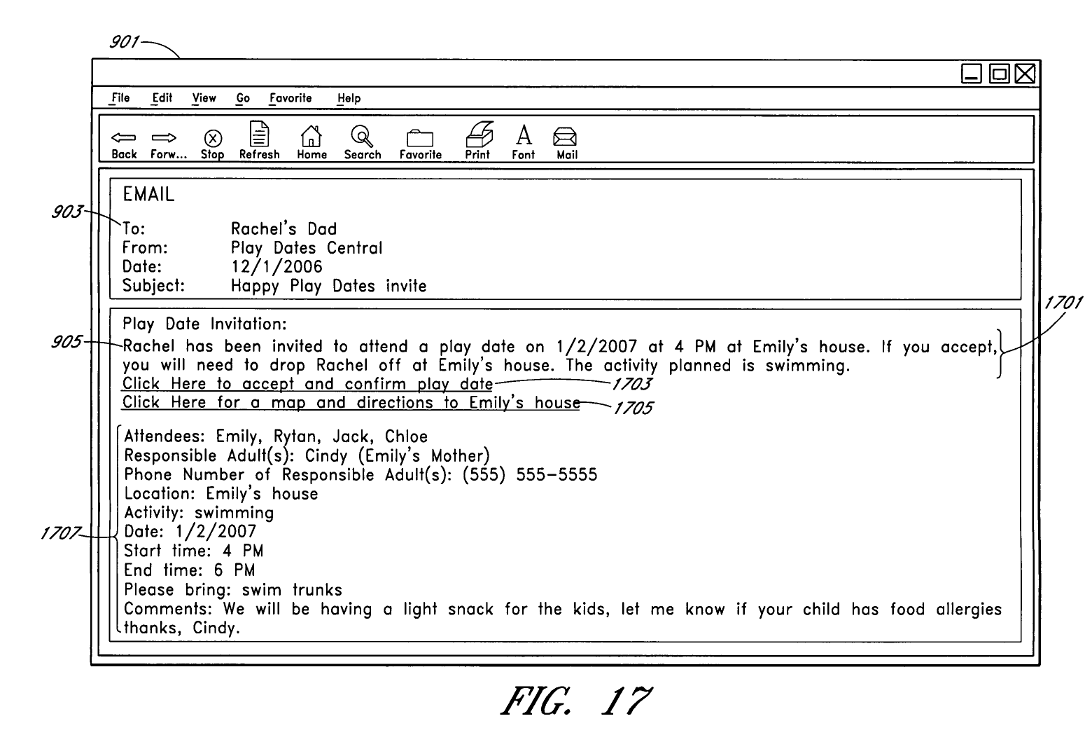

FIG. 17 illustrates one embodiment of a play date invitation e-mail. Once the user has chosen their favorites to invite, and possibly an activity as well, the system or the user can then send an invitation to the chosen favorites to invite them to a play date. E-mail 901 has header information 903 and a body 905. The body 905 has personalized information 1701 which quickly identifies the purpose of the email and expresses the invitation. The link 1703 is provided to allow a user to quickly accept and confirm a play date. In one embodiment, an acceptance time period is specified in which an invitation must be accepted to allow time for planning. In one embodiment, a link is provided to decline or to offer a rain check for a play date. In one embodiment, a link is provided to suggest another time. In one embodiment, a link is provided to access comments about the invitor or other invitees. The link 1705 is provided to allow a user to quickly find out where a play date will occur. The play date summary 1707 is provided as a quick summary of the important information about the play date, such as, for example, who is invited, who will supervise, where it is going to take place, what activity is involved, how far away the play date location is located, the date, the phone number of the person supervising, the cell phone number of the person supervising, the start time, the end time, things to bring, as well as other comments about the play date. An invitation can also be sent by mail, or by phone. The invitations can be automatically generated and sent out, the invitations can be automatically generated and personalized before being sent, or a user can generate their own invitation from scratch. In one embodiment, after the invitation is accepted, the user or the invitees can suggest an activity for the play date.

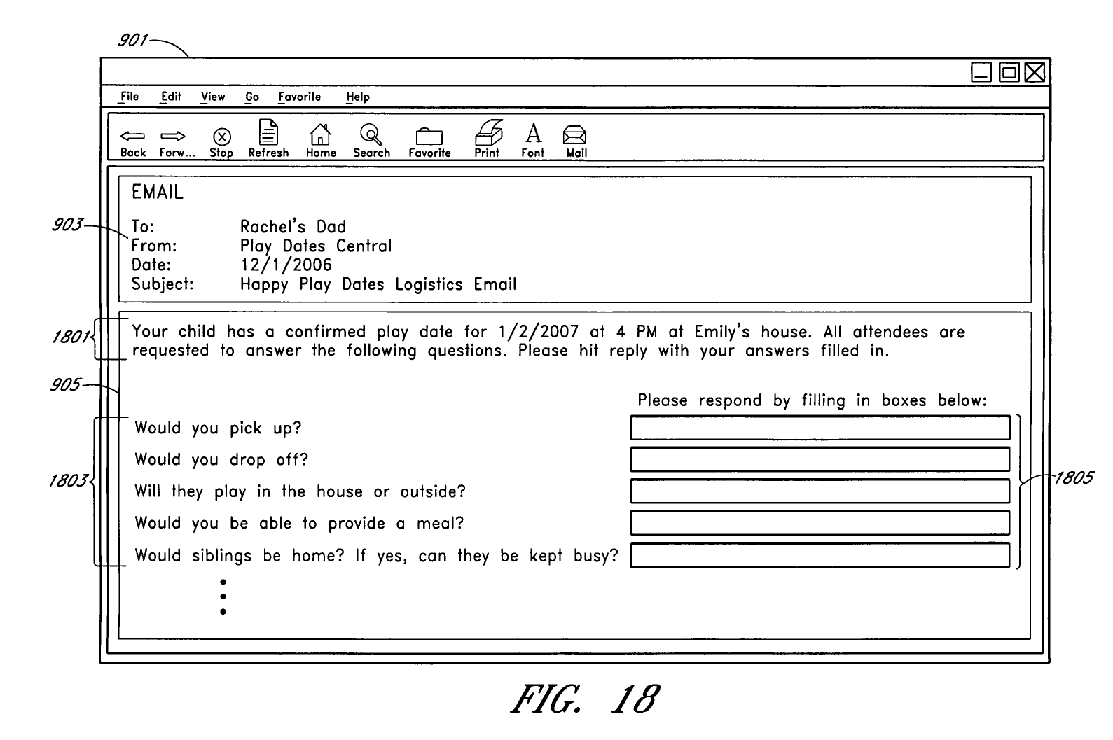

FIG. 18 illustrates a play date logistics e-mail. Once play date invitations have been accepted, the invitees, including the user requesting the play date, are sent a logistics e-mail in which the user is requested to answer certain questions 1903. Questions 1903 can include: “would you pick up or drop off;” “will a meal or snack be provided;” “what time will you pick up;” “what time will you drop off;” “do you have a spare child seat in your car;” “will they play in the house;” “will they play outside the house;” “will there be any special activity planed;” “should we talk over the phone about the activity;” “would you be able to provide the meal;” “will siblings be home,” “if yes, can they be kept busy;” “would they be going on to the street;” “will they be supervised:” etc.

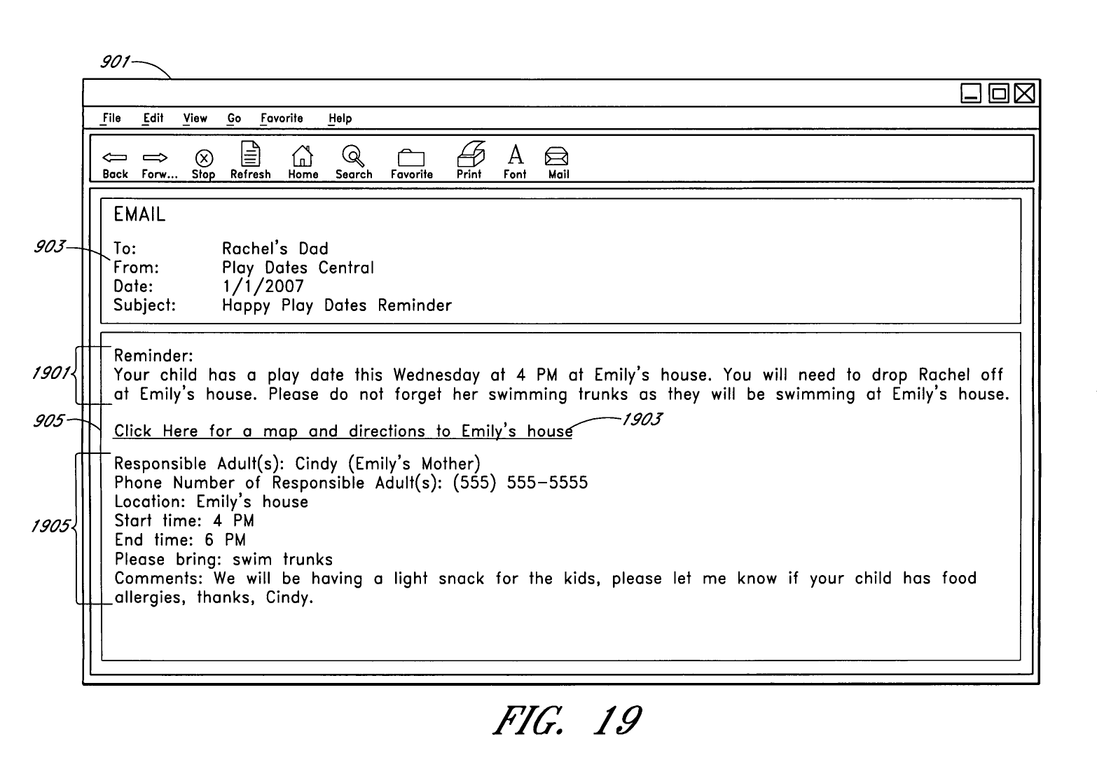

FIG. 19 illustrates one embodiment of a play date reminder e-mail. Within the body 905 of the e-mail 901 is text 1901 which summarizes the purpose of the e-mail 901, in this case, the e-mail 901 is sent to remind a user of a play date that has been scheduled and also to remind the user where, when, and what to bring as well as other pertinent information related to the scheduled play date. The text 1905 is provided as a short summary of the facts of the play date. This summary can include who the responsible adults are, what the phone number of the responsible adult is, what the cell phone number the responsible adult is, the location of the play date, the start time of the play date, the end time of the play date, a list of things to bring, as well as comments about the play date. The link 1903 is provided so that the person receiving the e-mail is able to quickly find maps and directions to get to the play date.

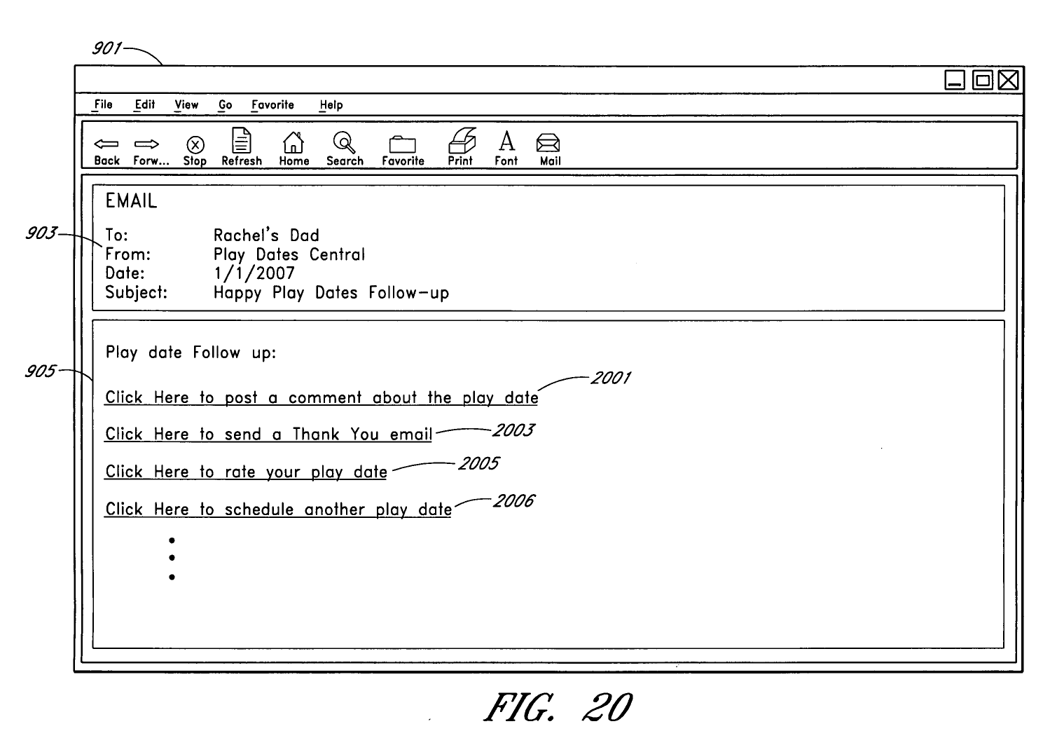

FIG. 20 illustrates one embodiment of a play date follow-up e-mail. After the completion of a play date, an automatic e-mail 901 is generated and sent to all play date participants to follow up on what happened at the play date. The body 905 contains a number of links that a user can click on in order to go to various network pages and enter follow-up information about the play date, for example, the link 2001 is provided to quickly direct a user to a network page which allows them to post comments about the play date. The link 2003 is provided to allow a user to quickly send a thank you e-mail to others who were involved in the play date. The link 2005 is provided to direct the user to a rate your play date page where the user can rate the play date. The link 2006 is provided to quickly direct a user to a page which allows the user to schedule another play date with the same and/or other groups of children. Other links can include: click here to log into your account, click here to change preferences, click here to schedule the same play date again, click here to schedule a play date with the same children, click here to schedule a play date with different children, as well as other useful links.

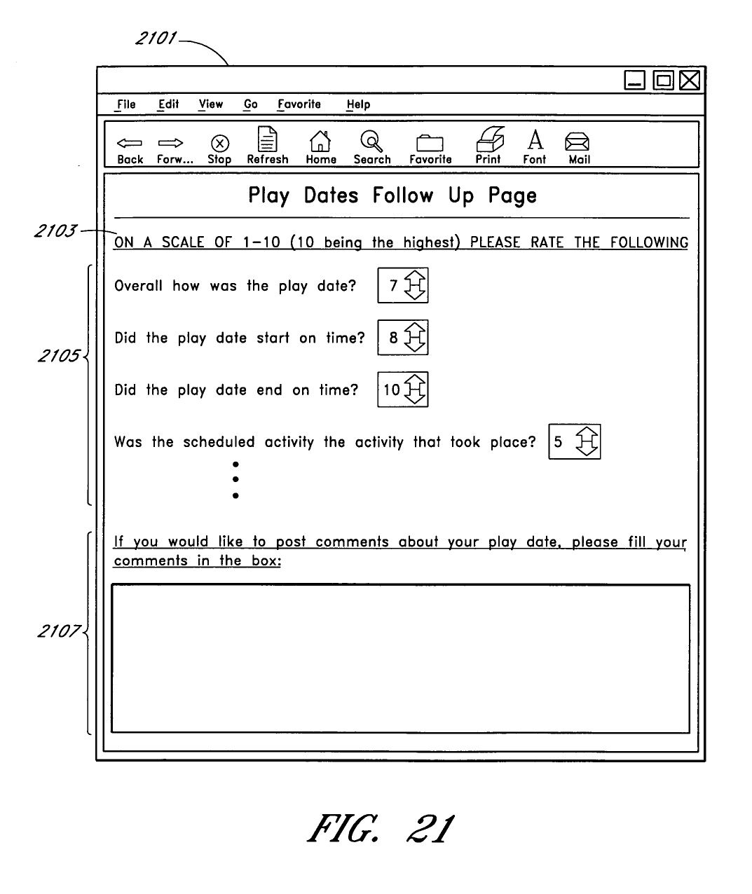

FIG. 21 illustrates one embodiment of a play date follow-up network page 2101. The play date follow-up page 2101 has the rating section 2103 and the comments section 2107. The rating section 2103 allows the user to rate various aspects of the play date. For example, the user can rate overall how the play date went, whether the play date started on time, how close the scheduled activity was to the activity that took place, etc. In comments section 2107, the user can submit comments about the play date. Other aspects to rate can include such things as: did the correct people drive, was there food at the activity, was the food at the activity good, how was the activity, how were you treated, how did the parents treat you, how did the play date treat you, how did the siblings of the play date treat you, how was the environment of the location, as well as other useful comments in rating a play date. In one embodiment, comments submitted in area 2107 are reviewed by the administrators of the play date scheduling system to eliminate negative, abusive, or otherwise inappropriate comments. In one embodiment, a user can choose to make the feedback private or public. In one embodiment, a user can select other users, or a group of users to share the information with. In one embodiment, a user can select whether they want to supply feedback for statistical purposes only.

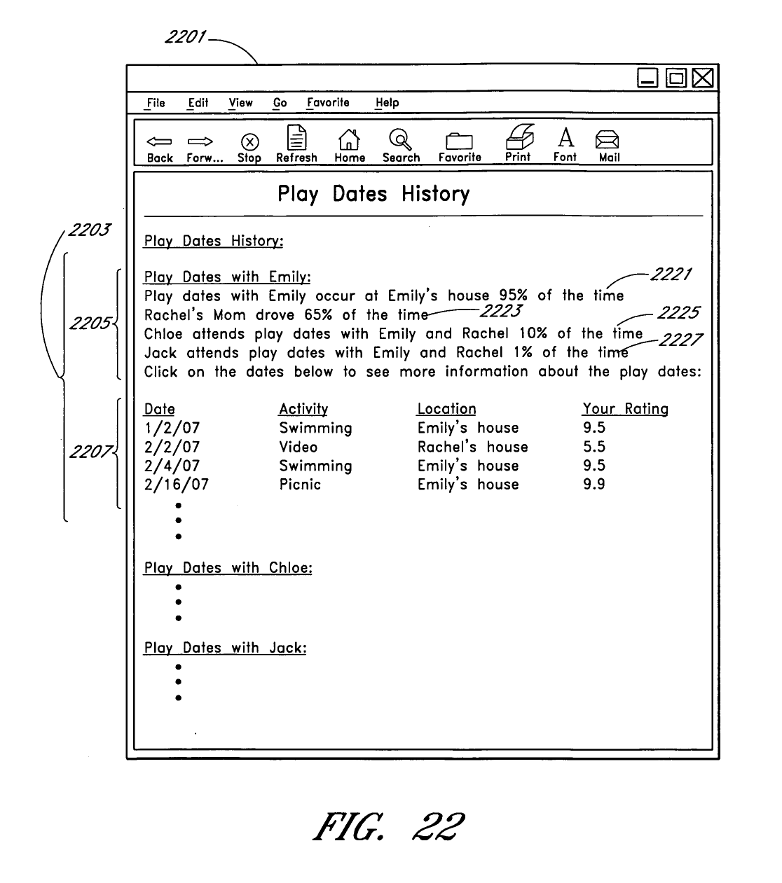

FIG. 22 illustrates one embodiment of a play date history network page 2201. The play date history page 2201 lists a set of facts related to the history of the play dates of a particular user. For example, in one embodiment, the play date history page breaks down the various play dates that a user has had by favorites. The history page 2201 lists information about the play date. For example, the text 2221 displays the statistics for how often play dates occur at a particular person's house. In one embodiment, the history page displays statistics about play dates. For example, in one embodiment, the history page displays statistics on activities participated in, such as, for example, most frequent activities, success rate, failure rate, who participated in the activities, how successful the activity was based on the participants, etc. The text 2223 illustrates a particular statistic for how often a particular parent drove. The text 2225 illustrates how often another child attended a play date along with the user and the particular favorite that is being listed. The text 2207 lists the date, activity, location, and the user's rating of the various play dates that have taken place. In one embodiment, the play date history page 2201 lists information according to activities participated in, dates and times of play dates, people participating within the play dates, the location of the play dates, the rating of the play dates, the comments left of the play dates, the comments that other people left concerning the play dates, what food was given to the children of the play dates, who supervised the play dates, who drove to the play dates, and any other information relative to play dates. In one embodiment, the history page 2201 can be rearranged according to the preferences of the user.

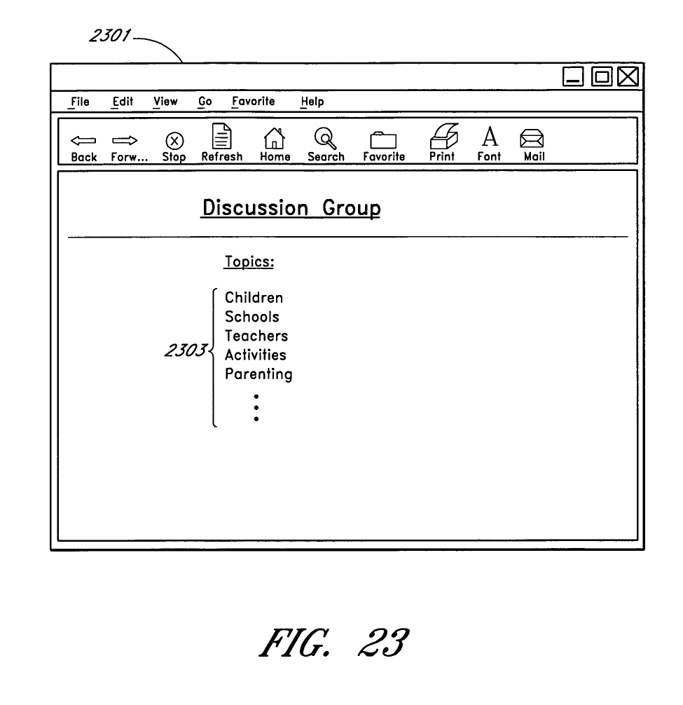

FIG. 23 illustrates one embodiment of a discussion group page 2301. The discussion group page 2301 lists topics 2303 that either children or parents can click on in order to link to various discussion groups. For example, the topics 2303 can include anything about children, schools, teachers, activities, parenting or any other discussion group topics. In one embodiment, the children are not allowed to participate in discussion groups and only the parents are. In one embodiment, only the children are allowed to participate in discussion groups and the parents are restricted out of them. In one embodiment, children are mainly intended to participate in the discussion groups but parents are allowed to monitor them. In one embodiment, certain topics are provided for the children to participate in and certain topics are provided for the parents to participate in. In one embodiment, comments posted to the discussion group pages are manually or automatically reviewed by administrators before being posted to ensure that nothing inappropriate is posted. In one embodiment, the system automatically changes names (including misspelled names) included in feedback to a fictitious names. In one embodiment, the system automatically deletes names included in feedback comments. In one embodiment, the topics can be made public or private between two or more users, or a specified group of users.

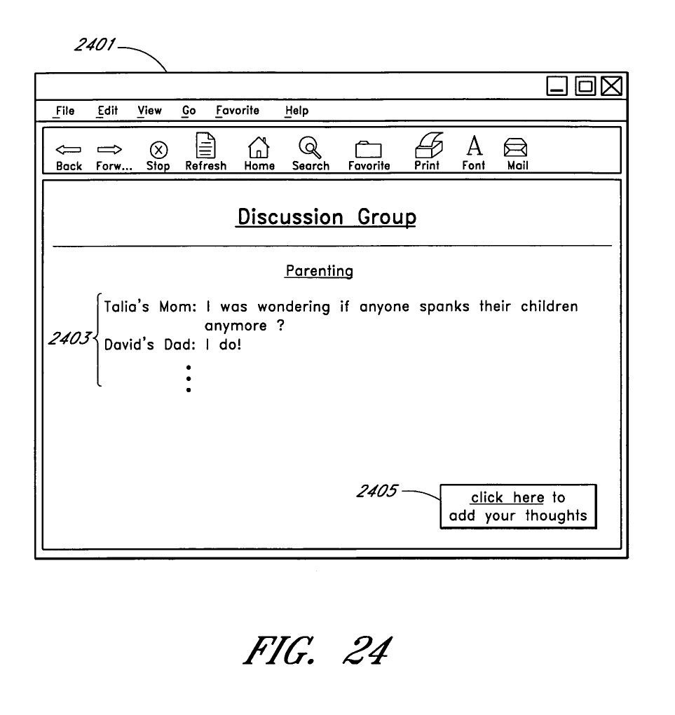

FIG. 24 illustrates one embodiment of a discussion thread page 2401. Discussion thread page 2401 displays the comments 2403 posted by users about that topic. A user is allowed to add their own comments to the threads of comments that have already been posted on the particular discussion group thread page 2401. A user can add comments by, for example, clicking on click here to add your thought link 2405.

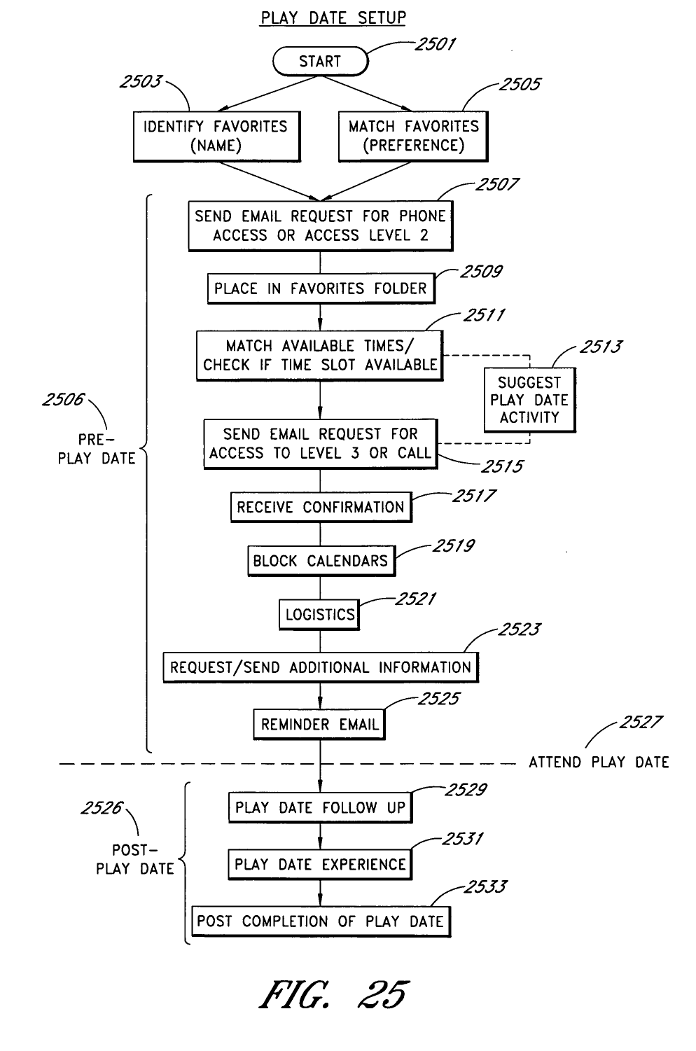

FIG. 25 illustrates a flow chart of one embodiment of a play date set up. The play date scheduling system starts at start block 2501 where a user chooses to begin the scheduling process. The system then moves either to identify favorites block 2503 or to match favorites block 2505. At identify favorites page 2503, a user can find a favorite by name, if the user knows who he or she is looking for, or at block 2505, a user can automatically find a favorite through a computer selection system by entering criteria as described above. In either case, from block 2503 or 2505, the system moves to block 2507 where a user sends an e-mail or other message request to a potential favorite the user has identified in order to access security level 2 so that the user can find out more information about the potential favorite. In one embodiment, the message request is a request to exchange phone numbers to discuss the security access clearance.

Once access has been granted by a particular favorite, the favorite is placed into a favorites folder at block 2509. The system then moves on to block 2511 where the scheduling system either automatically finds an available time for a play date, or allows a user to manually find an available time for a play date. Once a date and time has been chosen at block 2511, the system moves on to block 2513 or block 2515. At block 2513, the system suggests a play date activity and then moves on to block 2515. At block 2515, the user can optionally send an e-mail requesting access to level 3 information. In one embodiment, instead of emailing to request information, a user can make a phone call in order to aid in scheduling a play date, or send a message requesting a phone number exchange. The system then moves on to block 2517 where all the invitees of the play date, as well as the user, receives a play date confirmation e-mail where the user is allowed to confirm that the user will or will not attend a particular play date invitation. The system then moves on to block 2519 where the system blocks out the calendars of all the invitees that have accepted so that another overlapping play date cannot be scheduled during the scheduled play date time. The system then moves on to block 2521 where the system sends out an e-mail regarding logistics.

At block 2523, the system sends or requests additional information. In addition, the user or participant logs on at anytime and alter or cancel their attendance at a particular play date if something else comes up. If a user modifies or cancels their attendance at a play date, an email is automatically sent out to all invitees informing them of the change. In one embodiment, cancellation information is also recorded for statistical purposes and is displayed in the history page. At block 2525, a reminder e-mail is sent to all the participants in the play date so that the user can be reminded of when the play date is going to occur. The reminder e-mail can either be sent one day before, one hour before, one week before, or any other appropriate amount of time before a play date to remind everybody about the play date. In one embodiment, users can set their own settings as to how soon before a play date the user wants to be sent a reminder email. In one embodiment, the reminder box 2525 includes an automatic phone messaging system where a system automatically dials a user and gives a voice recording stating that a play date has been scheduled for a particular date, time and place.

Between block 2525 and block 2519, at point 2527, the play date takes place. After the play date, at block 2529, a play date follow up e-mail is sent to all of the participants in the play date as described above. At block 2531, the system posts the play date experience, and at block 2533, the system posts completion of the play date and populates the play date history page.

FIG. 26 illustrates various security levels 2601, 2603, 2605. For example, security level 1 2601 represents the security level of information available to all registered users. Security level 2 2603 represents the security level of specific information which is only available to a specified group upon being given security clearance by the user. Similarly, security level 3 2605 represents the security level of information which is only available to specific users who are granted permission by the user. More or fewer security levels can also be used. For example, in one embodiment, four security levels are provided. In one embodiment, a user can grant security level clearance on a parameter by parameter basis.

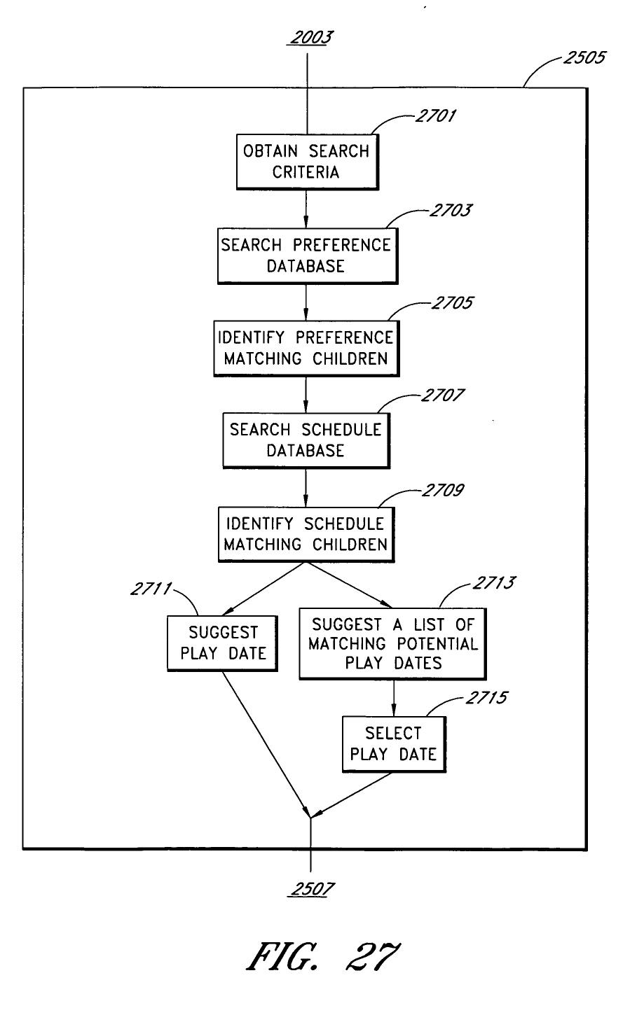

FIG. 27 illustrates one embodiment of a flow chart of match favorites block 2505. Match favorites block 2505 starts by requesting search criteria be entered at block 2701 by the user. The match favorites block then moves on to search preferences block 2703 where the system searches through the database of child preferences that have been entered during the registration process to find children whose preferences are similar to those of the preferences entered by the user. The system then moves on to block 2705 where the system identifies matching children. At block 2707, the system searches the schedule database for children whose schedules are available for a play date with the user. At block 2709, the system identifies children whose schedules match with the user schedule. The system then moves on to either block 2711 or block 2713. At block 2711, the system suggests a play date, if there are more than one potential play dates that are identified, either at block 2709 or 2705, then the system picks the play date with the highest percent matching preferences and suggest that play date. If, on the other hand, the system moves on to block 2713, the system suggests a list of matching potential play dates along with the percent of preferences matched with the user. At block 2715, the user then selects which play date he wants to schedule a play date with. The system then moves on to block 2507 as previously discussed with reference to FIG. 25.

Although the foregoing invention has been described in terms of certain preferred embodiments, other embodiments will be apparent to those of ordinary skill in the art from the disclosure herein. For example, although the communications envisioned by the present disclosure are provided via email, other forms of communication can also be used, for example, text messaging, instant messaging, phone calls, faxes, or other forms of communication can also be used. Additionally, other combinations, omissions, substitutions and modifications will be apparent to the skilled artisan in view of the disclosure herein. It is contemplated that various aspects and features of the invention described can be practiced separately, combined together, or substituted for one another, and that a variety of combination and sub combinations of the features and aspects can be made and still fall within the scope of the invention. Furthermore, the systems described above need not include all of the modules and functions described in the preferred embodiments. Accordingly, the present invention is not intended to be limited by the recitation of the preferred embodiments, but is to be defined by reference to the appended claims.

What is claimed is:

1. A network-based scheduling system, the system comprising:
a child schedule database comprising a plurality of child schedules, wherein the plurality of child schedules comprises a first child schedule corresponding to a first child;
a child parameter database comprising a plurality of child parameter sets, wherein the plurality of child parameter sets comprises a first child parameter set corresponding to the first child;
a parent database comprising a first parent schedule;
a parameters module configured to compare the first child parameter set with the plurality of child parameter sets in the child parameter database in order to find one or more second child parameter sets, wherein each second child parameter set in the second child parameter sets comprises at least one similar parameter to the first child parameter set;
a scheduling module configured to compare the first child schedule and the first parent schedule with the plurality of child schedules in the child schedule database in order to find one or more second child schedules, wherein each of the second child schedules in the second child schedules have one or more open time periods that correspond to open time periods on the first child schedule and the first parent schedule;
an identification module configured to identify one or more children with a parameter list and a schedule on the one or more second child parameter sets and the one or more second child schedules in order to suggest one or more children with whom the first child can schedule an event; and
a communication module configured to communicate with the one or more children about the event.

2. The network-based scheduling system of claim 1, wherein the child schedule database and the child parameter database comprise a single database.

3. The network-based scheduling system of claim 1, wherein the plurality of child schedules in the child schedule database comprise child schedules corresponding to the one or more second child parameter sets.

4. The network-based scheduling system of claim 1, wherein the plurality of child preference sets in the child preference database comprise child preference sets corresponding to the one or more second child preference sets.

5. The network-based scheduling system of claim 1, wherein the communication module is further configured to communicate an event invitation.

6. The system of claim 1, wherein the communication module is further configured to communicate an event reminder.

7. The system of claim 1, wherein the communication module is further configured to communicate a follow up request after the event.

8. The system of claim 1, further comprising:
a parent parameter database comprising a first parent parameter set; and
wherein the parameters module is further configured to compare the first parent parameter set with the first child parameter set and the plurality of child parameter sets in the child parameter database in order to find one or more second child parameter sets, wherein each second child parameter set in the second child parameter sets comprises at least one similar parameter to the first child parameter set and the first parent parameter set.

9. A method for matching a first child with a second child for an event comprising:
providing a database of child parameters comprising at least a set of first child parameters of a first child and a second child parameters of a second child;
providing a database of child schedules comprising at least a first child schedule of the first child and a second child schedule of the second child;
providing a database of parent schedules comprising at least a first parent schedule of a first parent, wherein the first parent is the parent of the first child;
coordinating the schedules of the first parent and the first child based on the first child schedule and the first parent schedule;
searching the database of child schedules for a subset of child schedules that coordinate with at least one period of time with the coordinated schedule of the first parent and the first child;
identifying the subset of child schedules that coordinate with at least one period of time with the coordinated schedules of the first parent and the first child;
searching the database of child parameters for a subset of child parameter sets that have one or more similar parameters to the set of first child parameters;
identifying the subset of child parameter sets that have one or more similar parameters to the set of first child parameters;
comparing the identified subset of child schedules with the identified subset of child parameter sets for a child listed on both subsets; and
identifying one or more children listed on both subsets.

10. The method of claim 9, wherein identifying one or more children listed on both subsets further comprises:
searching for a child with the most similar set of parameters when two or more children are listed on both subsets; and
identifying the child with the most similar set of parameters.

11. A network-based scheduling system, the system comprising:
a child database comprising a first child schedule and a second child schedule;
a parent database comprising a first parent schedule;
a scheduling module configured to compare the first and second child schedules and the first parent schedule in order to match an open time period on the first child schedule, the second child schedule, and the first parent schedule in order to schedule an event; and
a logistics module configured to coordinate the logistics associated with attending the event.

12. The network based scheduling system of claim 1, further comprising a communication interface for communication between the schedule module and a user.

13. The network based scheduling system of claim 12, wherein communication further comprises an invitation email.

14. The network based scheduling system of claim 12, wherein communication further comprises a reminder email.

15. The network based scheduling system of claim 12, wherein communication further comprises a follow up email.

16. The network based scheduling system of claim 12, wherein the schedule module is further configured to schedule an event.

17. The network based scheduling system of claim 16, further comprising a history module for recording information about completed events.

18. The network based scheduling system of claim 16, further comprising an activities module for suggesting events.

19. The network based scheduling system of claim 12, wherein the child database further comprises a set of child parameters.

20. The network based scheduling system of claim 12,

21. The network based scheduling system of claim 12, wherein the child database further comprises location information about a first child.

22. The network based scheduling system of claim 12, wherein the location information further comprises distance information.

23. The network based scheduling system of claim 22, wherein the interest information comprises affiliation information.

24. The network based scheduling system of claim 23, wherein the affiliation information comprises school affiliation.

25. The network based scheduling system of claim 23, wherein the affiliation information comprises religious affiliation.

26. A scheduling method for scheduling a child play date comprising:
providing a first child schedule;
providing a second child schedule;
providing a first parent schedule;
coordinating the first child schedule, the second child schedule, and the first parent schedule in order to schedule an event; and
wherein coordinating the parent schedule further comprises coordinating a transportation period.

27. The scheduling method of claim 26, wherein coordinating the transportation period comprises coordinating a transportation period at the beginning of the event.

28. The scheduling method of claim 26, wherein coordinating the transportation period comprises coordinating a transportation period at the end of the event.

29. The scheduling method of claim 26, wherein coordinating the transportation period comprises coordinating a transportation period at the beginning and the end of the event.

30. The scheduling method of claim 26, further comprising:
providing a second parent schedule; and
wherein coordinating the first child schedule, the second child schedule, and the first parent schedule in order to schedule an event, further comprises coordinating the second parent schedule.

31. A network-based social interface system comprising:
one or more databases;
a registration module configured to obtain and store registration information of one or more users on the one or more databases;
a calendar module configured to obtain and store schedule information of the one or more users on the one or more databases;
a user finder module configured to obtain parameter information from a first user and search the one or more databases for a subset of the one or more users that have registration information that is similar to the obtained parameters and store identification information of the subset of the one or more users on the one or more databases; and
a communication module configured to communicate with the one or more users.

32. The system of claim 31, wherein the first user comprises a child.

33. The system of claim 31, wherein the first user comprises a parent.

34. The system of claim 31, further comprising a scheduling module configured to compare schedule information of the subset of one or more users with schedule information of the first user.

35. The system of claim 31, further comprising a discussion group module configured post comments from the one or more users.

36. The system of claim 31, wherein the communication module is further configured to communicate an invitation to the subset of one or more users.

37. The system of claim 31, wherein the communication module is further configured to communicate a reminder.

38. The system of claim 31, wherein the communication module is further configured to request feedback about an event.

39. The system of claim 38, further comprising a history module configured to store and display history information about an event.

40. A method of scheduling a social event, the method comprises:
obtaining scheduling information about a first user and one or more second users;
obtaining a plurality of social event requests from a first user for the one or more second users; and
automatically scheduling a social event between the first user and the one or more of the second users in response to one or more of the plurality of social event requests and the occurrence of an event.

41. The method of claim 40, wherein the event comprises a passage of time.

42. The method of claim 40, wherein the event comprises a completion of a previous event.

43. The method of claim 40, wherein the event comprises a user input.

44. An event scheduling probability based scheduling system comprising:
a calendar database comprising a plurality of scheduled events; and
a probability module configured to compute a probability of scheduling an event at a specified time based on the scheduled events in the calendar database;

45. The scheduling system of claim 44, further comprising a display module configured to display the probability computed by the probability module.

46. The scheduling system of claim 44, wherein the probability module is further configured to compute the probability of scheduling an event during a blocked out period.

47. The scheduling system of claim 44, wherein the probability module is further configured to compute the probability of scheduling an event during a non-blocked out period.

48. The scheduling system of claim 44, further comprising a calendar module configured to display a calendar displaying the plurality of scheduled events.

49. An event history system comprising:
an events database comprising feedback information about events;
a statistical module configured to compute statistical information based on the feedback information; and
a display module for displaying computed the statistical information.

50. The event history system of claim 49, wherein statistical information comprises statistical information about one or more participants of an event.

51. The event history system of claim 49, wherein statistical information comprises statistical information about one or more activities at the event.

52. The event history system of claim 49, wherein statistical information comprises statistical information about logistic information associated with the event.
